(19) United States
(12) Patent Application Publication
(10) Pub. No.: US 2021/0400510 A1
(43) Pub. Date: Dec. 23, 2021

(54) ELECTRONIC DEVICE, METHOD AND STORAGE MEDIUM FOR WIRELESS COMMUNICATION SYSTEM

(71) Applicant: Sony Group Corporation, Tokyo (JP)

(72) Inventors: Ziyuan SHA, Beijing (CN); Zhaocheng WANG, Beijing (CN); Jianfei CAO, Beijing (CN)

(73) Assignee: Sony Group Corporation, Tokyo (JP)

(21) Appl. No.: 17/295,874

(22) PCT Filed: Nov. 27, 2019
(86) PCT No.: PCT/CN2019/121100

§ 371 Date: May 21, 2021

(30) Foreign Application Priority Data
Nov. 29, 2018 (CN) 201811450540.4

(51) Int. Cl. H04W 24/08; H04B 17/345; H04W 24/10; H04W 72/04

(52) U.S. Cl. CPC H04W 24/08; H04W 72/046; H04W 24/10; H04B 17/345

(57) ABSTRACT

The present disclosure relates to an electronic device, a method, and a storage medium for a wireless communication system. Various embodiments regarding inter-cell interference measurement are described. In one embodiment, an electronic device for a terminal side in a wireless communication system may include a processing circuit that can be configured to measure a plurality of downlink beams of a serving cell, to determine one or more weak beams from the plurality of downlink beams for the terminal; measure interferences from one or more neighboring cells when the one or more weak beams are used to transmit a first signal; and transmit interference measurement results, measured when at least one weak beam is used, to a base station of the serving cell.

### CROSS-REFERENCES TO RELATED APPLICATIONS

This application claims the priority of Chinese Patent Application No. 201811450540.4 filed on Nov. 29, 2018. The entire content of which is incorporated hereby into this application by reference.

### TECHNICAL FIELD

The present disclosure relates generally to interference measurement in a wireless communication system, and in particular, to a technology for measuring inter-cell interference.

### BACKGROUND

In recent years, with the development and wide application of mobile Internet technology, wireless communication has unprecedentedly met people's needs for voice and data communication. In order to provide even higher communication quality and capacity, wireless communication system employs various technologies at different layers, such as Beamforming techniques. Beamforming can provide beamforming gain to compensate for loss of radio signals by increasing the directivity of antenna transmission and/or reception. In future wireless communication systems (such as 5G systems like NR (New Radio) system, for example), the number of antenna ports at the base station and terminal device sides will further increase. For example, the number of antenna ports at the base station side may increase to hundreds or even more, constituting a Massive MIMO system. Thus, in large-scale antenna systems, beamforming will have a larger application space.

In scenarios where beamforming is used, for a user at the edge of a serving cell, inter-cell interferences may be related to beam usage of neighboring cells. For example, when there is a downlink beam directed to the user in a neighboring cell, the user will suffer inter-cell interference. As the number of beams increases, the interference situation between several neighboring cells becomes more complicated. Accordingly, more resources and processes are required to measure inter-cell interference.

### SUMMARY

One aspect of the present disclosure relates to an electronic device for a terminal side in a wireless communication system. According to one embodiment, the electronic device can comprise a processing circuit. The processing circuit can be configured to measure a plurality of downlink beams of a serving cell, to determine one or more weak beams from the plurality of downlink beams for the terminal; measure interferences from one or more neighboring cells when the one or more weak beams are used to transmit a first signal; and transmit interference measurement results, measured when at least one weak beam is used, to a base station of the serving cell.

One aspect of the present disclosure relates to an electronic device for a base station side in a wireless communication system. According to one embodiment, the electronic device comprises a processing circuit. The processing circuit can be configured to transmit a first signal by a plurality of downlink beams of a serving cell; and to receive interference measurement results, measured when at least one weak beam is used, from a terminal, where the interference measurement results are obtained by the terminal by measuring interferences from one or more neighboring cells when one or more weak beams for the terminal are used to transmit the first signal.

Another aspect of the present disclosure relates to a wireless communication method. In one embodiment, the method can comprise measuring a plurality of downlink beams of a serving cell, to determine one or more weak beams from the plurality of downlink beams for the terminal; measuring interferences from one or more neighboring cells when the one or more weak beams are used to transmit a first signal; and transmitting interference measurement results, measured when at least one weak beam is used, to a base station of the serving cell.

Another aspect of the present disclosure relates to a wireless communication method. In one embodiment, the method can comprise transmitting a first signal by a plurality of downlink beams of a serving cell; and receiving interference measurement results, measured when at least one weak beam is used, from a terminal, where the interference measurement results are obtained by the terminal by measuring interferences from one or more neighboring cells when one or more weak beams for the terminal are used to transmit the first signal.

Yet another aspect of the present disclosure relates to a computer-readable storage medium having one or more instructions stored thereon. In some embodiments, the one or more instructions may, when executed by one or more processors of an electronic device, cause the electronic device to perform the methods in accordance with various embodiments of the present disclosure.

Still another aspect of the present disclosure relates to various apparatus, comprising components or units for performing operations of the methods in accordance with embodiments of the present disclosure.

The above summary is provided to summarize some exemplary embodiments in order to provide a basic understanding of the various aspects of the subject matter described herein. Therefore, the above-described features are merely examples and should not be construed as limiting the scope or spirit of the subject matter described herein in any way. Other features, aspects, and advantages of the subject matter described herein will become apparent from the Detailed Description described below in conjunction with the drawings.

### BRIEF DESCRIPTION OF THE DRAWINGS

A better understanding of the present disclosure can be achieved by referring to the detailed description given hereinafter in connection with the accompanying drawings, wherein:

FIG. 1 depicts an exemplary beam scanning process in a wireless communication system.

FIG. 2 is a schematic diagram of a plurality of downlink beams of a base station and a terminal according to an embodiment.

FIG. 3A illustrates an exemplary electronic device for a terminal side according to an embodiment.

FIG. 3B illustrates an exemplary electronic device for a base station side according to an embodiment.

FIG. 4 illustrates an example process between a base station and a terminal for measuring inter-cell interference according to an embodiment.

FIG. 5A illustrates a measurement example of a strong beam and a weak beam.

FIG. 5B illustrates a report example of beam measurement according to an embodiment.

FIG. 6 illustrates an example of time-frequency resource configuration for inter-cell interference measurement according to an embodiment.

FIGS. 7A and 7B illustrate an example of a scenario for measuring inter-cell interference according to an embodiment.

FIG. 7C illustrates an example of interference measurement results report according to an embodiment.

FIGS. 8A and 8B illustrate signaling operations between a base station of a serving cell and a base station of a neighboring cell according to an embodiment.

FIG. 9 illustrates an example process between a base station and a terminal for measuring inter-cell interference and tracking beams according to an embodiment.

FIG. 10 illustrates an example form of beam selection information according to an embodiment.

FIGS. 11A to 11D illustrate exemplary use cases of the solution according to the present disclosure in a 5G NR system.

FIGS. 12A and 12B illustrate an example method for communication according to an embodiment.

FIG. 13 is a block diagram of an example structure of a personal computer as an information processing device that can be employed in an embodiment of the present disclosure;

FIG. 14 is a block diagram showing a first example of a schematic configuration of a gNB to which the technology of the present disclosure can be applied;

FIG. 15 is a block diagram showing a second example of a schematic configuration of a gNB to which the technology of the present disclosure can be applied;

FIG. 16 is a block diagram showing an example of a schematic configuration of a smartphone to which the technology of the present disclosure can be applied;

FIG. 17 is a block diagram showing an example of a schematic configuration of a car navigation device to which the technology of the present disclosure can be applied; and

FIG. 18 illustrates a simulation diagram of measuring beam strength according to the present disclosure.

The embodiments described in the present disclosure are only examples, and they may have various modifications and alternatives. It should be understood that the drawings and detailed description thereof are not intended to limit solutions to the specific forms disclosed, but to cover all modifications, equivalents, and alternatives falling within the spirit and scope of the claims.

### DETAILED DESCRIPTION

The following describes representative applications of various aspects of the device and method according to the present disclosure. The description of these examples is merely to add context and help to understand the described embodiments. Therefore, it is clear to those skilled in the art that the embodiments described below can be implemented without some or all of the specific details. In other instances, well-known process steps have not been described in detail to avoid unnecessarily obscuring the described embodiments. Other applications are also possible, and the solution of the present disclosure is not limited to these examples.

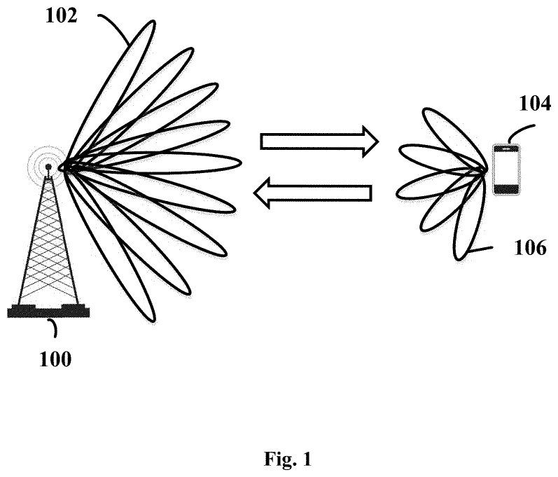

The following briefly introduces a beam scanning process in a wireless communication system in connection with FIG. 1. The arrow to the right in FIG. 1 indicates the downlink direction from a base station 100 to a terminal device (hereinafter referred to as terminal) 104, and the arrow to the left indicates the uplink direction from the terminal 104 to the base station 100. As shown in FIG. 1, the base station 100 includes n_{t_DL} downlink transmitting beams (n_{t_DL} is a natural number greater than or equal to 1, and exemplified in FIG. 1 as n_{t_DL}=9), and the terminal 104 includes n_{r_DL} downlink receiving beams (n_{r_DL} is a natural number greater than or equal to 1, exemplified in FIG. 1 as n_{r_DL}=5). In addition, in the wireless communication system shown in FIG. 1, the number of uplink receiving beams n_{r_UL} of the base station 100 and the coverage of each beam are the same as those of downlink transmitting beams, and the number of uplink transmitting beams n_{t_UL} of the terminal 104 and the coverage of each beam are the same as those of downlink receiving beams. It should be understood that, according to the system requirements and settings, the coverage and the number of uplink receiving beams and downlink transmitting beams of a base station may be different, and the same is true for a terminal device.

As shown in FIG. 1, during a downlink beam sweeping process, each downlink transmitting beam 102 of the n_{t_DL} downlink transmitting beams of the base station 100 transmits n_{r_DL} downlink reference signals to the terminal 104, and the terminal 104 receives the n_{r_DL} downlink reference signals through the n_{r_DL} downlink receiving beams respectively. In this way, the n_{t_DL} downlink transmitting beams of the base station 100 sequentially transmit n_{t_DL}×n_{r_DL} downlink reference signals to the terminal 104, and each downlink receiving beam 106 of the terminal 104 receives n_{t_DL} downlink reference signals, that is, the n_{r_DL} downlink receiving beams of the terminal 104 receive a total of n_{t_DL}×n_{r_DL} downlink reference signals from the base station 100. The terminal 104 measures the n_{t_DL}×n_{r_DL} downlink reference signals (for example, measuring the received signal power (for example, RSRP) of the downlink reference signals), so that the downlink transmitting beam of the base station 100 and the downlink receiving beam of the terminal 104 when the measurement result is better or the best are determined as the transmitting and receiving beam pair matched in the downlink.

During a uplink beam sweeping process, similar to the downlink beam sweeping, each uplink transmitting beam 106 of the n_{t_UL} uplink transmitting beams of the terminal 104 transmits the N_{r_UL} uplink reference signals to the base station 100, and the base station 100 receives the N_{r_UL} uplink reference signals through the N_{r_UL}, uplink receiving beams respectively. In this way, the n_{t_UL} uplink transmitting beams of the terminal 104 sequentially transmit n_{t_UL}×n_{r_UL} uplink reference signals to the base station 100, and each uplink receiving beam 102 of the base station 100 receives n_{t_UL} uplink reference signals, that is, the n_{r_UL} uplink receiving beams of the base station 100 receive a total of N_{r_UL}×n_{t_UL} uplink reference signals from the terminal 104. The base station 100 measures the N_{r_UL}×n_{t_UL} uplink reference signals (for example, measures the received signal power (for example, RSRP) of the uplink reference signals), so that the uplink transmitting beam of the terminal 104 and the uplink receiving beam of the base station 100 when the measurement result is better or the best are determined as the transmitting and receiving beam pair matched in the uplink.

It should be understood that the coverage and the number of uplink receiving beams and downlink transmitting beams of a base station may be different and the coverage and the number of uplink transmitting beams and downlink receiving beams of a terminal device may be different, and above determination operations can still be carried out similarly.

In the above example, the terminal 104 uses all n_{r_DL} downlink beams or n_{t_UL} uplink beams for reference signal transmission and reception during the downlink or uplink beam scanning process. In the embodiments of the present disclosure, this beam scanning process is referred to full beam scanning. In some cases, in order to quickly complete the beam scanning process, the terminal 104 may use a single beam (for example, an omnidirectional beam) for reference signal transmission and reception during the downlink or uplink beam scanning process. This beam scanning process may be referred to fast beam scanning.

Receiving beams and transmitting beams of a base station and a terminal device can be generated by a Discrete Fourier Transform (DFT) vector. A downlink transmitting beam at a base station side is used below as an example for description. An uplink receiving beam at a base station side and a transmitting beam and a receiving beam at a terminal device side can also be generated by similar methods.

For example, assuming that a base station side is equipped with nₜ transmitting antennas, an equivalent channel from the base station to a terminal device can be expressed as one nₜ×1 vector H. The DFT vector u can be expressed as:

$$u = {[ \begin{matrix}1 & {e}^{j \frac{2 π}{C}} … {e}^{j \frac{2 π ( {n}_{t} - 1 )}{C}}\end{matrix} ]}^{T} \qquad [ Equation 1 ]$$

Wherein, the length of the DFT vector u is nₜ, C represents a parameter for adjusting the beam width and beamforming gain, and “T” represents a transposition operator. One transmitting beam of the base station can be obtained by multiplying the equivalent channel H from the base station to the terminal device by the DFT vector u (for example, one of the downlink transmitting beams shown in FIG. 1).

In one embodiment, the parameter C for adjusting the beam width and beamforming gain in Equation 1 can be expressed by the product of two parameters O₂ and N₂, and by adjusting the two parameters O₂ and N₂, respectively, the beam width and beamforming gain can be adjusted. Generally, the larger the number of antennas nₜ or the larger the parameter C (for example, the product of O₂ and N₂), the stronger the spatial directivity of the obtained beam, but the narrower the beam width in general. In one embodiment, O₂=1 and N₂=1 can be taken, and the DFT vector u thus obtained is a vector in which nₜ elements are all 1.

After the downlink beam scanning and uplink beam scanning processes are completed, the established beam pair is utilized to perform subsequent transmission of data and/or control signal. The above processes of determining the matched transmitting and receiving beam pairs of a base station and a terminal device through beam scanning is sometimes also referred to as a Beam Training process.

In scenarios where beamforming is used, for a specific terminal, strengths of downlink beams of a base station are different. For example, the beam matched with the specific terminal may be a strong beam for the terminal, and when a base station uses this beam to transmit a signal, the terminal may receive a stronger signal; beams that are not close to the matched beam may be weak beams for the terminal, and when the base station uses these beams to transmit a signal, the terminal may receive weaker signals or even fail to receive signals. Hereinafter, in general, when simple expressions such as strong and weak beams and matched beams are used, they are for a specific terminal, and the specific meaning can be understood in combination with the context.

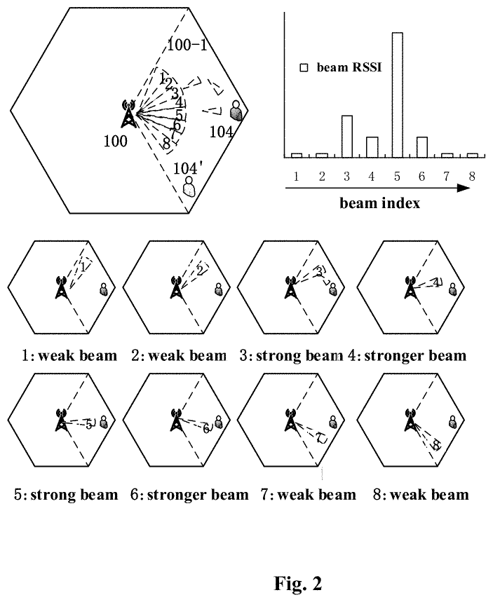

FIG. 2 is a schematic diagram of a plurality of downlink beams of a base station and a terminal according to an embodiment. In FIG. 2, a cell 100-1 of a base station 100 is a serving cell of a terminal 104. In a communication system, there are other cells (not shown) adjacent to the cell 100-1, and the terminal 104 may be located at the edge of the cell 100-1 or at a location that may suffer interference by the neighboring cells. As shown in FIG. 2, the base station 100 can set 8 available downlink beams (denoted as beam 1 to beam 8 respectively) for the cell 100-1, and use only one beam for downlink transmission at any time. In an embodiment, a downlink beam of the base station that directs to the terminal may be a strong beam for the terminal. In the example of FIG. 2, beam 5 and beam 3 correspond to LOS path and NLOS path from the base station 100 to the terminal 104, respectively, which will have strong coverage/influence on the terminal 104, and therefore have high contribution to the signal reception result (for example, the strength indicators, such as RSSI) of the terminal 104. In an embodiment, a downlink beam of a base station that does not direct to a terminal but will cover the terminal may be a stronger beam for the terminal. In the example of FIG. 2, side lobes of the beam 4 and the beam 6 will have coverage/influence on the terminal 104, so the beam 4 and the beam 6 may also have contribution to the signal reception result of the terminal 104. In an embodiment, downlink beams of a base station that does not cover a terminal may be weak beams for the terminal. In the example of FIG. 2, the beams 1, 2, 7, and 8 will not (or hardly) have coverage/influence on the terminal 104, and therefore have little contribution to the signal reception result of the terminal 104.

In an embodiment of the present disclosure, a terminal can distinguish downlink beams of a base station of a serving cell into weak beams and strong beams (or further stronger beams, weaker beams) through beam measurement (for example, during beam scanning). In an embodiment, there may be a threshold regarding beam strength. Accordingly, a downlink beam with received signal to interference and noise ratio or a received power lower than a certain threshold for a terminal can be determined as a weak beam for the terminal, and a downlink beam with received signal to interference and noise ratio or a received power higher than a certain threshold for a terminal can also be determined as a strong beam for the terminal (stronger beams and weaker beams can be similarly determined). In the example of FIG. 2, the beams 1, 2, 7, and 8 may be determined as weak beams for the terminal 104, and other beams may be determined as strong or stronger beams for the terminal 104.

When a base station of a serving cell uses a strong beam for a specific terminal for communication, the base station notifies the terminal of the time-frequency transmission resource corresponding to the strong beam so that it can perform corresponding reception; when the base station uses a weak beam (which may be a strong beam for other terminals) for the terminal for communication, the terminal may not perform corresponding reception (reception may be performed by other corresponding terminals). In the example of FIG. 2, when the base station 100 uses beam 3 or beam 5 for downlink transmission, since these beams are strong beams for the terminal 104, the base station 100 notifies the terminal 104 of the time-frequency transmission resource corresponding to these beams, so that the terminal 104 may perform corresponding reception. When the base station 100 uses beam 8 for downlink transmission, since the beam is a strong beam for the terminal 104′, the terminal 104′ can similarly obtain the time-frequency transmission resources corresponding to the strong beam to perform corresponding reception; accordingly, the terminal 104 may not know the time-frequency transmission resource corresponding to the weak beam, so may not perform corresponding reception. In an embodiment, a terminal may use an occasion when a base station of a serving cell is using a weak beam to communicate with other terminals to perform other operations, for example, to measure inter-cell interference. For example, a terminal can receive on a strong beam, and measure inter-cell interference on some or all of the weak beams (that is, it is not necessary to use a strong beam to measure inter-cell interference). In the example of FIG. 2, the terminal 104 may measure the inter-cell interference when the weak beams 1, 2, 7, and 8 are used for communication with other terminals (for example, the terminal 104′). In this way, when time-frequency resources are used for transmission with corresponding terminals through strong beams, other terminals can use corresponding occasions to measure inter-cell interference, which is beneficial to improve time efficiency. From another perspective, when a terminal measures inter-cell interference by utilizing an occasion when the weak beam therefor is used, corresponding time-frequency resources are being used for communication with other terminals. Inter-cell interference measurements do not need to occupy extra time-frequency resources, which is beneficial to improve resource efficiency. Therefore, compared to a solution that must rely on a strong beam to measure inter-cell interference, the solution according to the embodiment can improve the time efficiency and resource efficiency of inter-cell interference measurement. In general, in the case that beamforming is used, inter-cell interference may come from one or more beams of one or more neighboring cells, that is, the granularity of interference sources is at beam level. In addition, in the embodiment, measuring inter-cell interference when a weak beam is used and tracking a strong beam when a strong beam is used may be performed in parallel.

In an embodiment, after inter-cell interference measurement is performed, a terminal may transmit interference measurement results, measured when one or more weak beams are used, to a base station of a serving cell according to the configuration of the base station. The terminal may transmit part or all of the interference measurement results according to the configuration. For example, the terminal may transmit one or more interference measurement results (for example, the one with the strongest interference or the one the base station expected to measure). Accordingly, based on the interference measurement results, the base station can determine whether there is inter-cell interference for the specific terminal. In some embodiments, based on the interference measurement results, the base station of the serving cell may also determine and/or infer neighboring cells and their beams which caused interferences based on beam usages of neighboring cells.

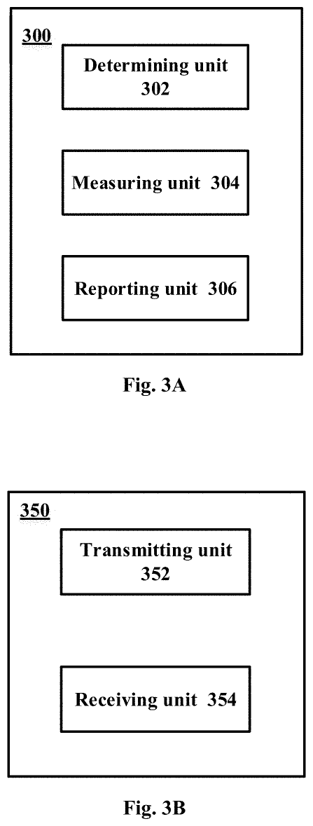

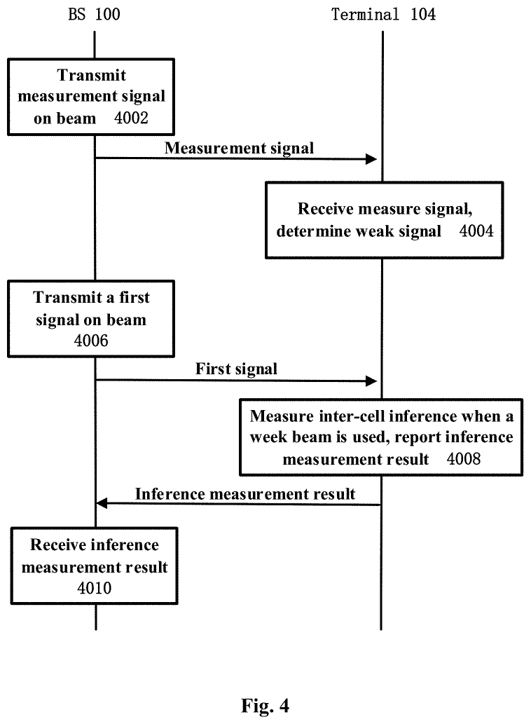

FIG. 3A illustrates an exemplary electronic device for a terminal side according to an embodiment, wherein the terminal can be used in various wireless communication systems. The electronic device 300 in FIG. 3A may include various units to implement various embodiments according to the present disclosure. As shown in FIG. 3A, the electronic device 300 may include a determining unit 302, a measuring unit 304, and a reporting unit 306. In one implementation, the electronic device 300 may be implemented as foregoing terminal 104 or a part thereof. Various operations described below in connection with a terminal may be implemented by the units 302 to 306 of the electronic device 300 or other possible units.

In an embodiment, the determining unit 302 may be configured to measure a plurality of downlink beams of a serving cell to determine one or more weak beams from the plurality of downlink beams for the terminal. In an embodiment, the measuring unit 304 may be configured to measure interferences from one or more neighboring cells when the one or more weak beams are used to transmit a first signal. In an embodiment, the reporting unit 306 may be configured to transmit at least one interference measurement result, measured when the weak beam is used, to a base station of the serving cell.

It should be understood that the term terminal herein has the full breadth of its normal meaning, for example, a terminal may be a Mobile Station (MS), User Equipment (UE), and so on. A terminal can be implemented as a device such as a mobile phone, a handheld device, a media player, a computer, a laptop or a tablet, or a wireless device of almost any type. In some cases, a terminal can communicate using multiple wireless communication technologies. For example, a terminal may be configured to communicate using two or more of GSM, UMTS, CDMA2000, WiMAX, LTE, LTE-A, WLAN, 5G NR, Bluetooth, etc. In some cases, a terminal may also be configured to communicate using only one wireless communication technology.

FIG. 3B illustrates an exemplary electronic device for a base station side according to an embodiment, wherein the base station can be used in various wireless communication systems. The electronic device 350 in FIG. 3B may include various units to implement various embodiments according to the present disclosure. As shown in FIG. 3B, the electronic device 350 may include a transmitting unit 352 and a receiving unit 354. In one implementation, the electronic device 350 may be implemented as foregoing base station 100 or a part thereof, or may be implemented as a device (such as a base station controller) used to control the base station 100 or otherwise associated with the base station 100 or part of it. Various operations described below in connection with a base station may be implemented by the units 352 to 354 of the electronic device 350 or other possible units.

In an embodiment, the transmitting unit 352 may be configured to transmit a first signal by a plurality of downlink beams of a serving cell. In an embodiment, the receiving unit 354 may be configured to receive at least one interference measurement result, measured when a weak beam is used, from a terminal. Wherein, the interference measurement results are obtained by the terminal by measuring interferences from one or more neighboring cells when one or more weak beams for the terminal are used for downlink transmission.

It should be understood that the term base station herein has the full breadth of its normal meaning, and at least includes a wireless communication station that is a wireless communication system or a part of a radio system to facilitate communication. Examples of a base station may include but are not limited to the following: at least one of a base transceiver station (BTS) and a base station controller (BSC) in a GSM system; at least one of a radio network controller (RNC) and a Node B in a WCDMA system; eNBs in LTE and LTE-Advanced systems; access points (APs) in WLAN and WiMAX systems; and corresponding network nodes in communication systems to be or under development (for example, gNB, eLTE eNB in 5G NR systems, etc.). Part of functions of a base station herein can also be implemented as an entity that has control functions to communication in the D2D, M2M, and V2V communication scenarios, or as an entity that plays a role of spectrum coordination in the cognitive radio communication scenario.

In some embodiments, the electronic devices 300 and 350 may be implemented at the chip level, or may also be implemented at the device level by including other external components. For example, each electronic device can work as a communication device as a whole machine.

It should be understood that the above various units are only logical modules divided according to the specific functions they implement, and are not intended to limit specific implementations, for example, they can be implemented in software, hardware, or a combination of software and hardware. In actual implementation, the above various units may be implemented as independent physical entities, or may be implemented by a single entity (for example, a processor (CPU or DSP, etc.), an integrated circuit, or the like). Wherein, the processing circuitry may refer to various implementations of a digital circuitry, an analog circuitry, or a mixed signal (combination of analog and digital) circuitry that perform functions in a computing system. The processing circuitry can comprise, for example, a circuit such as an integrated circuit (IC), an application specific integrated circuit (ASIC), a portion or circuit of a separate processor core, the entire processor core, a separate processor, a programmable hardware device such as a field programmable gate array (FPGA), and/or a system including multiple processors.

FIG. 4 illustrates an example process between a base station and a terminal for measuring inter-cell interference according to an embodiment. This example process can be executed by the electronic device 300 and the electronic device 350 described above.

In the example of FIG. 4, similarly, the base station 100 is a serving cell base station of the terminal 104. As shown in FIG. 4, at 4002, the base station 100 may transmit measurement signals on multiple beams (for example, beam 1 to beam 8 in FIG. 2). In an embodiment, the measurement signal may be at least one of a reference signal (for example, a reference signal in a 5G NR system, such as a channel state information reference signal CSI-RS) or a synchronization signal (for example, a synchronization signal block SSB in an NR system).

At 4004, the terminal 104 may measure a plurality of beams of the base station 100 by receiving measurement signals to determine one or more weak beams from the plurality of beams for the terminal 104. In an embodiment, a downlink beam with received signal to interference and noise ratio (SNIR) or received power (RSRP) lower than a threshold for the terminal can be determined as a weak beam for the terminal. As mentioned above, there may be thresholds regarding beam strength. These thresholds may be preset by the wireless communication system, may be determined by the base station and the terminal through signaling negotiation, or may be determined by the terminal itself (for example, the threshold is determined based on measurement results of a plurality of beams, so that one or more beams with the lowest SNIR or RSRP are determined as weak beams).

At 4006, the base station 100 may transmit a first signal on each beam (for example, beam 1 to beam 8 in FIG. 2). The first signal here may be the same as or different from the measurement signal at 4002. For example, the measurement signal at 4002 may be a synchronization signal, and the first signal here may be a synchronization signal, a reference signal, or a data signal. For another example, the measurement signal at 4002 may be a synchronization signal or a reference signal, and the first signal here may be a reference signal or a data signal. In an embodiment of the present disclosure, the first signal is non-zero power.

At 4008, the terminal 104 may measure inter-cell interferences when the weak beam is used, and transmit corresponding interference measurement results to the base station 100. In an embodiment, when the weak beam of the base station 100 is used for downlink transmission, the terminal 104 may measure downlink signals from multiple cells. At this time, a plurality of beams of neighboring cells may be being used to transmit reference signals, synchronization signals, or data signals, etc., and these signals may be measured by the terminal 104. Since weak beams of the serving cell contributes little to the reception of the terminal 104, the measured downlink signal at this time can be regarded as the inter-cell interference of a certain beam of the neighboring cell to the terminal 104. It should be understood that, when a strong beam for the terminal 104 is used and the terminal 104 is receiving, if the beam of the neighboring cell is also used, the inter-cell interference of the beam of the neighboring cell to the terminal 104 is equivalent to the aforementioned interference measurement result. Then, the terminal can transmit the interference measurement result to the base station in any suitable form.

At 4010, the base station 100 may receive the interference measurement results from the terminal 104. In some embodiments, the base station 100 may determine whether the downlink transmission of the neighboring cell will cause interference to the terminal 104 based on the interference measurement results. In other embodiments, the base station 100 can further determine/infer the source of inter-cell interference for the terminal 104 based on the interference measurement results, for example, from which beam of which neighbor cell the interference comes. If it is determined based on the interference measurement results that there is inter-cell interference (for example, caused by a certain beam of a certain cell), it can be considered that, when a strong beam for the terminal 104 is used for downlink transmission, there will also be corresponding inter-cell interference caused by the beam of the cell.

An example process of a base station and a terminal is generally described above in connection with FIG. 4. In this example process, the first signal is non-zero power, that is, the base station may not have to transmit a zero-power signal (for example, a zero-power reference signal, such as ZP-CSI-RS) for the purpose of inter-cell interference measurement. This is at least because the terminal can measure inter-cell interferences when weak beams are used. Because it is not necessary to transmit zero-power signals, time-frequency transmission resources can be effectively utilized. Hereinafter, specific aspects related to inter-cell interference measurement according to the embodiment will be described.

### Beam (Strength) Measurement and Report

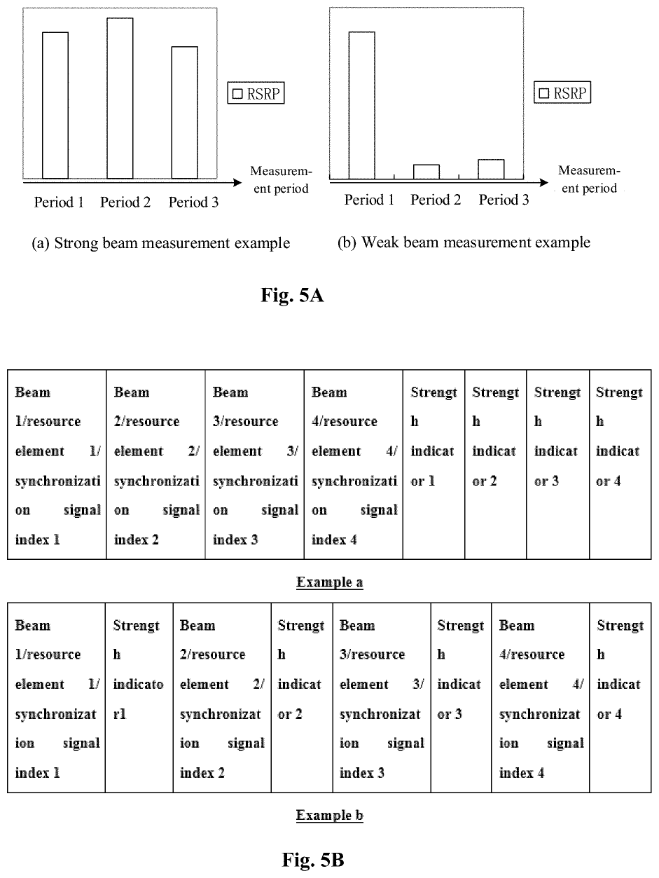

In the embodiment, one or more weak beams for a terminal are determined based on a single measurement result of each of a plurality of downlink beams, or based on statistics for multiple measurement results of each of the plurality of downlink beams. The number of measurements for each beam may be predetermined by the wireless communication system or determined by the terminal itself. In some cases, it may be more beneficial to perform multiple measurements for each beam. For example, signals received by a terminal may include signals transmitted by both a serving cell and a neighboring cell, and high received SNIR or RSRP may be caused by the signals of both the serving cell and the neighboring cell, therefore, the terminal may not be able to accurately determine the strength of a serving cell beam based on a single measurement. FIG. 5A illustrates a measurement example of a strong beam and a weak beam. The example on the left side of FIG. 5A is 3 measurements of a strong beam. Since the beam itself is a strong beam, the RSRP of each measurement is higher, regardless of whether the beam of the neighboring cell that is transmitted simultaneously with it is a strong beam or a weak beam. The example on the right side of FIG. 5A is 3 measurements of a weak beam. Since the beam itself is a weak beam, if the beam of the neighboring cell that is transmitted simultaneously with it is a strong beam, the measured RSRP is higher; if the beam of the neighboring cell that is transmitted simultaneously with it is a weak beam, the measured RSRP is lower. Therefore, performing multiple measurements on each beam (for example, through multiple periods of beam scanning process) can more accurately determine the strength of the beam.

It should be understood that the determined weak beam (or strong beam) may be different for different terminals. For example, in FIG. 2, beams 1, 2 and 7, 8 are weak beams for terminal 104; however, beam 8 is a strong beam for terminal 104′.

In some embodiments, after a terminal measures each beam (for example, obtains RSRP), the strength of the beam may be determined by the terminal (for example, based on threshold comparison) and fed it back to a base station. In some embodiments, after measuring each beam, the terminal may transmit measurement results of each beam (for example, RSRP) to the base station, and the base station determines the strength of the beams (for example, based on threshold comparison). In an embodiment, information of the beam measurement may be transmitted by the terminal to the base station in the form of a combination of beam ID/resource indicator (for example, CRI, CSI-RS Resource Indicator)/synchronization signal index (for example, SSB index) and beam strength indicator. FIG. 5B illustrates a report example of beam measurement according to an embodiment. As illustrated in the figure, report example a is composed of two parts: a set of beam IDs/resource indicators/synchronization signal indexes and a set of beam strength indicators (for example, RSRPs). The set of beam IDs/resource indicators/synchronization signal indexes include IDs of each beam or corresponding resource element indicators or synchronization signal indexes, and the set of beam strength indicators include measured values of each beam strength or results of comparison with the threshold. Although only 4 beams are included in example a, the embodiments of the present disclosure are not limited thereto. As illustrated in the figure, report example b is composed of multiple sets of beam IDs/resource indicators/synchronization signal indexes and beam strength indicators. Each set includes the ID of a single beam or the corresponding resource indicator or synchronization signal index and the measured value of the beam strength or the result of comparison with the threshold. Likewise, the embodiments of the present disclosure are not limited to 4 beams.

In an embodiment, the strength of all or part of beams may be transmitted to a base station, and corresponding report may include strength indicators of all or part of the beams. For example, the base station can control through RRC signaling or downlink control information DCI signaling, so that the report of a terminal includes only strong beams (for example, to perform beam management) or only weak beams (for example, to help perform inter-cell interference measurement). In some embodiments, the base station can control through RRC signaling or DCI signaling, so that the report of the terminal includes a part of strong beams (for example, ranked top in strength) and/or a part of weak beams (for example, the weakest in strength).

### Resource Configuration for Interference Measurement

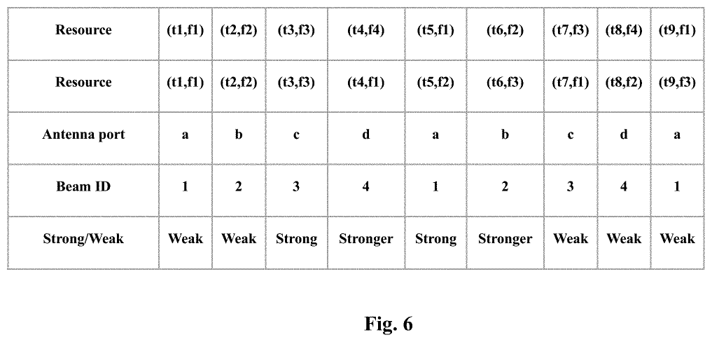

The following description still refers to the aforementioned base station 100 and terminal 104. For ease of description, it is assumed below that the base station 100 has 4 downlink beams for the cell 100-1, and the beam 3 is a strong beam for the terminal 104. FIG. 6 illustrates an example of time-frequency resource configuration for inter-cell interference measurement according to an embodiment. In an embodiment, the time-frequency resource of the base station 100 for inter-cell interference measurement may include a series of time-frequency resource elements (ti, fi), where ti and fi indicate the time-domain position and frequency-domain position of the time-frequency resource, respectively. (Assuming that time-frequency resources have fixed time-domain and frequency-domain sizes). According to the periodic change of the position in the frequency domain, the time-frequency resource element may exhibit a certain periodicity. As shown in FIG. 6, in resource configuration 1, the frequency domain position of the time-frequency resource element is repeated every 4 elements, so the period of the time-frequency resource element is 4; in resource configuration 2, the frequency domain position of the time-frequency resource element is repeated every 3 elements, so the period of the time-frequency resource element is 3. FIG. 6 further illustrates the correspondence between time-frequency resource elements, antenna ports and downlink beams. As illustrated in FIG. 6, the base station 100 of the serving cell 100-1 has 4 antenna ports a, b, c, and d, and the 4 antenna ports have corresponding time-frequency resource elements (ti, fi) respectively, and correspond to the downlink beams 1, 2, 3, and 4 respectively. In general, the period of time-frequency resource configuration is equal to the number of antenna ports or beams.

For example, the base station 100 may transmit a first signal of non-zero power on each downlink beam based on the resource configuration 1, so as to perform inter-cell interference measurement, for example. The first signal may be at least one of a reference signal (for example, a reference signal related to a channel state in a 5G NR system, such as CSI-RS) or a synchronization signal (for example, a synchronization signal block SSB in an NR system). In some embodiments, the first signal may also be a data signal. In an embodiment, the terminal 104 can measure inter-cell interferences when weak beams 1, 2, and/or 4 are used to transmit the first signal.

With reference to an existing LTE system, in order to measure inter-cell interference, a feasible method is to make a base station of a serving cell transmit a zero-power reference signal (for example ZP-CSI-RS) on a strong beam, so that a terminal receives the signal of the neighboring cell while receiving the zero-power reference signal of the serving cell, so that the reception result is regarded as inter-cell interference. In contrast, in an embodiment of the present disclosure, the terminal 104 utilizes an occasion that a base station transmit a non-zero power signal on a weak beam to measure inter-cell interference, which can both improve time efficiency (because of utilization of transmission occasion for other terminals), and save reference signal time-frequency resources (because there is no need to arrange a dedicated zero-power reference signal).

### Measurement and Reporting of Inter-Cell Interferences

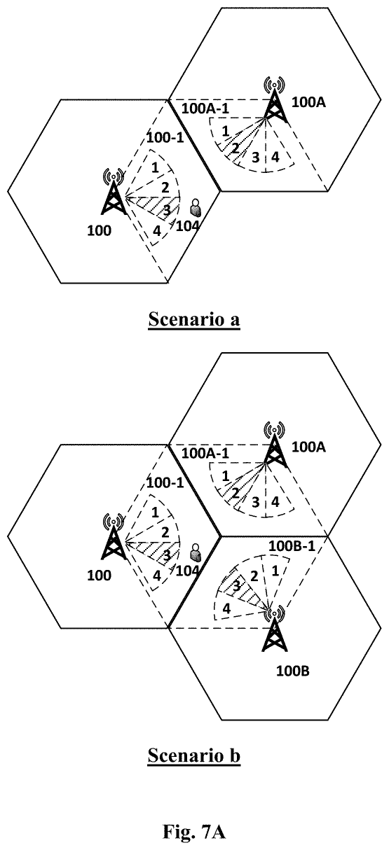

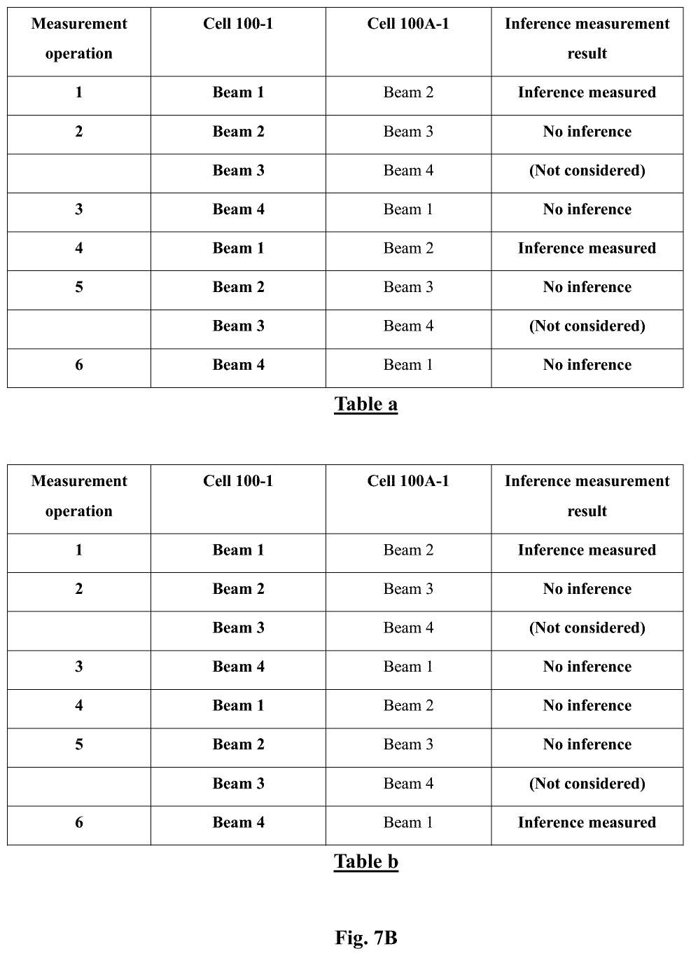

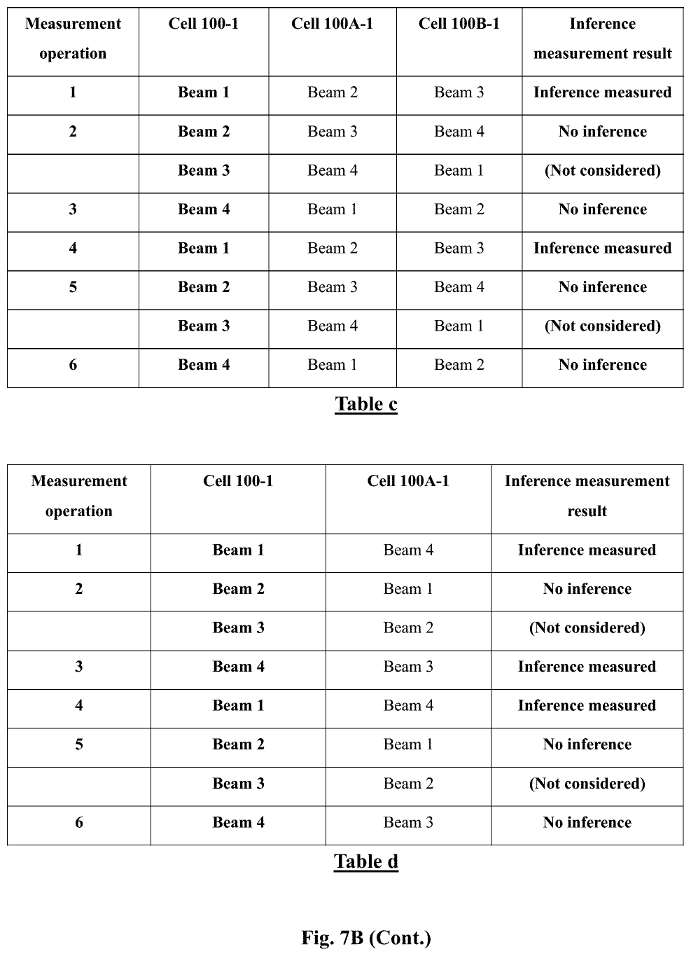

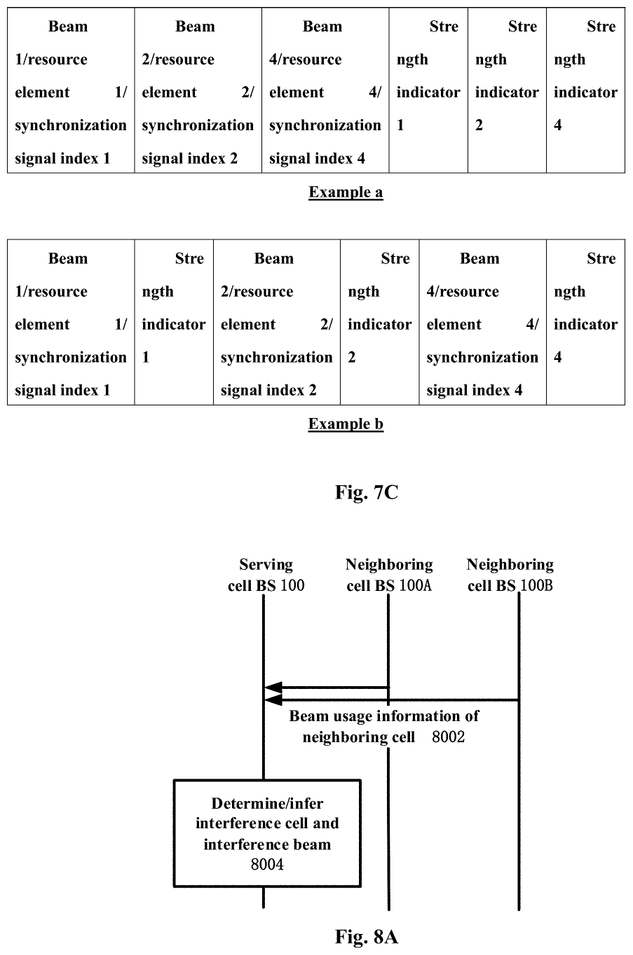

In an embodiment, interference measurement results may be based on a single interference measurement result or statistics for multiple interference measurement results. FIGS. 7A and 7B illustrate an example of a scenario for measuring inter-cell interference according to an embodiment, wherein FIG. 7A illustrates an example of a cell scenario, and FIG. 7B illustrates an example of interference measurement. In scenarios a and b in FIG. 7A, the cell 100-1 of the base station 100 is a serving cell of the terminal 104. In scenario a, there is a cell adjacent to cell 100-1, that is, cell 100A-1 of base station 100A; in scenario b, there are two cells adjacent to cell 100-1, that is, cell 100A-1 of base station 100A and cell 100B-1 of base station 100B. Each of the above cells is provided with 4 downlink beams. As illustrated in the figure, the beam 3 of the cell 100-1, the beam 2 of the cell 100A-1, and the beam 3 of the cell 100B-1 are directed to the terminal 104, assuming that none of the other beams will affect signal reception of the terminal 104. Therefore, the terminal 104 may first determine beams 1, 2, and 4 of the cell 100-1 as weak beams, and beam 3 as a strong beam. Next, the terminal 104 can measure signals from neighboring cell 100A-1 (in scenario a) or signals from neighboring cells 100A-1 and 100B-1 (in scenario b) when beams 1, 2, and 4 of the cell 100-1 are used, as the result of inter-cell interference.

In an embodiment, a base station of a serving cell generally configures periodic resources for measuring inter-cell interference, that is, time-frequency resources corresponding to beam/antenna ports are repeated periodically. In contrast, the base station of the neighboring cell may be in various possible states of serving its terminal, and the time-frequency resources used by it when the terminal of the serving cell measures the inter-cell interference may be repeated periodically, or may be occur randomly. In either case, interference sources can be determined/inferred based on the interference measurement results.

Tables a and b of FIG. 7B show the inter-cell interference measurement results performed by the terminal 104 in the two time-frequency resource periods of the base station 100 in a two-cell scenario a. In the example of Table a, the time-frequency resources used by the base station 100A when the terminal 104 measures the inter-cell interference are periodic. As shown in Table a, the terminal 104 has performed a total of 6 inter-cell interference measurements, where the inter-cell interferences were measured in the first and fourth operations. Therefore, it can be determined that, for the terminal 104 at the edge of the cell 100-1, there is interference from neighboring cell 100A-1 (because there is only one neighboring cell in this example, the cell as an interference source can be directly determined). Further, when a beam of the cell 100A-1 co-existing with interference is obtained, the beam as an interference source can be determined/inferred, as described in detail below.

In the example of Table b, the time-frequency resources used by the base station 100A when the base station 100 measures inter-cell interference are random. As shown in Table b, the terminal 104 also performed a total of 6 inter-cell interference measurements, where the inter-cell interferences were measured in the first and sixth operations. Therefore, it can be determined that, for the terminal 104 at the edge of the cell 100-1, there is interference from the neighboring cell 100A-1 (because there is only one neighboring cell in this example, the cell as an interference source can be directly determined). Further, when a beam of the cell 100A-1 co-existing with interference is obtained, the beam as an interference source can be determined/inferred, as described in detail below.

Tables c and d of FIG. 7B show the inter-cell interference measurement results performed by the terminal 104 in the two time-frequency resource periods of the base station 100 in a three-cell scenario b. In the example of Table c, when the terminal 104 measures inter-cell interferences, the time-frequency resources used by the base stations 100A and 100B are all periodic. As shown in Table c, the terminal 104 has performed a total of 6 inter-cell interference measurements, where the inter-cell interferences were measured in the first and fourth operations. Therefore, it can be determined that, for the terminal 104 at the edge of the cell 100-1, there is interference from neighboring cells (because there are 2 neighboring cells in this example, it is not yet possible to determine the cell as an interference source). Further, when obtaining beams of the cell 100A-1 and the cell 100B-1 existing with interference at the same time, the cell and the beam as an interference source can be determined/inferred, as described in detail below.

In the example of Table d, when the terminal 104 measures inter-cell interferences, the time-frequency resources used by the base station 100A are periodic, and the time-frequency resources used by the base station 100B are random. As shown in Table d, the terminal 104 has performed a total of 6 inter-cell interference measurements, where the inter-cell interferences were measured in the first, third, and fourth operations. Therefore, it can be determined that, for the terminal 104 at the edge of the cell 100-1, there is interference from neighboring cells (because there are 2 neighboring cells in this example, it is not yet possible to determine the cell as an interference source). Further, when beams of the cell 100A-1 and the cell 100B-1 co-existing with interference are determined, the cell and the beam as an interference source can be determined/inferred, as described in detail below.

As shown in FIG. 7A and FIG. 7B, since there may be more weak beams than strong beams in the serving cell. Therefore, compared with a solution of measuring inter-cell interference by transmitting a zero-power reference signal on a strong beam, there may be more measurement opportunities by using occasions of a weak beam to measure inter-cell interferences, and thus it is easier to measure inter-cell interferences. For example, in Table a, the interference beam 2 was measured in two operations in the above example. However, if the zero-power reference signal was transmitted only on the strong beam 3, the interference beam 2 cannot be measured.

In an embodiment, the interference measurement results, measured when at least one weak beam is used, are transmitted in a channel state information (CSI) report. The interference measurement results, measured when the at least one weak beam is used, may be transmitted along with an indication of time-frequency resources for a first signal on the at least one weak beam or with a beam ID of the at least one weak beam. The interference measurement results can be actual measurement values or processed measurement values (for example, normalized values that can reflect interference situations). In some examples, the interference measurement results can only indicate whether there is inter-cell interference (for example, by using “0” and “1” bits). FIG. 7C illustrates an example of interference measurement results report according to an embodiment. As shown in the figure, report example a is composed of two parts: a set of beam IDs/resource indicators/synchronization signal indexes and a set of interference strength indicators. The set of beam IDs/resource indicators/synchronization signal indexes include IDs of each beam or corresponding resource elements or synchronization signal indexes, and the set of interference strength indicators include inter-cell interference results measured when corresponding beams or resource elements or synchronization signals are used. Although interference measurement reports of only 3 beams are included in example a, the embodiments of the present disclosure are not limited thereto. As shown in the figure, report example b is composed of multiple sets of beam IDs/resource indicators/synchronization signal indexes and interference strength indicators. Each set includes the ID of a single beam or the corresponding resource indicators or synchronization signal indexes and inter-cell interference results measured when the corresponding beams or resource elements or synchronization signals are used. Likewise, the embodiments of the present disclosure are not limited to interference measurement reports of 3 beams.

In an embodiment, all or part of inter-cell interference measurement results may be transmitted to a base station, and corresponding report may include interference strength indicators when all or part of weak beams is used. For example, the base station can configure the number of interference measurement results in the report through RRC signaling or DCI signaling. Accordingly, the report of a terminal includes only some measurement results of stronger interferences or measurement results of beams that are expected to be measured.

### Determination of Inter-Cell Interference Sources

In some embodiments, the presence of inter-cell interference may be determined based on the measurement performed by a terminal when a weak beam is used. In some embodiments, the source of inter-cell interference can be further determined, which in one embodiment will involve communicating with neighboring cells.

As mentioned above, in the case that beamforming is used, inter-cell interference can come from one or more beams of one or more neighboring cells, that is, the granularity of interference sources is at the beam level. In the embodiments of the present disclosure, sources of inter-cell interferences for a specific terminal can be determined/inferred based on inter-cell interference measurement results and based on beam usage of neighboring cells, that is, which downlink beam(s) of which cell(s) inter-cell interferences come from. In some embodiments, time-frequency resources corresponding to interferences may be determined based on inter-cell interference measurement results, and it may be determined, based on the beam usage of the neighboring cell, which beam is being used by the neighboring cell when the serving cell uses the time-frequency resource. In some embodiments, time information corresponding to interference may be determined based on inter-cell interference measurement results, and it may be determined, based on the beam usage of the neighboring cell, which beam is being used by the neighboring cell at corresponding time. In one embodiment, the time information may be characterized as a slot index and/or a symbol index. In some embodiments, one or more downlink beams of one or more neighboring cells with interference are determined based on interference beam information within a certain period of time (for example, through multiple measurement samples). The operations related to determining sources of inter-cell interferences may be performed by a base station of a serving cell and/or a base station of a neighboring cell. Here, still referring to the examples of FIGS. 7A and 7B, an example process for which a base station of a serving cell and/or a base station of a neighboring cell determines/infers a neighboring cell and its downlink beam as a source of inter-cell interferences, is described.

As shown in Table a, taking measurement operation 1 as an example, the base station 100 can determine that the beam of the serving cell 100-1 corresponding to the interference is beam 1 based on inter-cell interference measurement results (further, corresponding time-frequency resources can be determined based on the correspondence between time-frequency resources and beams). The base station 100 (or the base station 100A) can further determine that the neighboring cell 100A-1 is using the beam 2 when the serving cell 100-1 uses the beam 1/corresponding time-frequency resource based on the beam usage of the neighboring cell 100A-1. Therefore, the beam 2 of the cell 100A-1 is a source of inter-cell interference for the terminal 104. Alternatively, the base station 100 may determine time information corresponding to the interference based on the inter-cell interference measurement result. The base station 100 (or the base station 100A) can further determine that the neighboring cell 100A-1 is using the beam 2 at corresponding time based on the beam usage of the neighboring cell 100A-1. Similarly, the beam 2 of the cell 100A-1 is a source of inter-cell interference for the terminal 104. Similarly, the source of inter-cell interference can be determined based on measurement operation 4.

In the example of Table a, time-frequency resources used by base station 100A when base station 100 measures inter-cell interferences are repeated in the same period as the time-frequency resources of base station 100, and beam combinations of the two cells are the same in different periods. Therefore, the interference measurement results can be determined based on either a single interference measurement (for example, operation 1 or operation 4) or based on multiple interference measurements (for example, considering both operation 1 and operation 4). In an embodiment, a base station of a serving cell can obtain the beam usage of a neighboring cell at any suitable time. For example, the base station 100 can obtain the beam usage of the cell 100A-1 before or after obtaining inter-cell interference measurement results.

In the example of Table b, the process of determining the source of inter-cell interference for the terminal 104 is similar to that of Table a. In Table b, the time-frequency resources used by the cell 100A when the base station 100 measures inter-cell interference are random, and beam combinations of the two cells are different in different periods. Therefore, in this example, it is necessary to determine interference measurement results based on any single interference measurement (for example, operation 1 or operation 6). Different beam combinations can result the determined interference source more accurate. For example, in Table b, the interference source determined based on measurement operation 1 (beam 2 of cell 100A-1) can be confirmed through measurement operation 6.

As shown in Table c, taking measurement operation 1 as an example, the base station 100 can determine that the beam of the serving cell 100-1 corresponding to the interference is beam 1 based on inter-cell interference measurement results (further, corresponding time-frequency resources can be determined based on the correspondence between time-frequency resources and beams). The base station 100 can further determine that the neighboring cells 100A-1 and 100B-1 are respectively using beam 2 and beam 3 when the serving cell 100-1 uses the beam 1/corresponding time-frequency resource based on the beam usage of the neighboring cells 100A-1 and 100B-1. Considering that no interference is measured in other measurement operations in the same time-frequency resource period, the base station 100 can determine/infer, based on the operation 1, that one or both of the beam 2 of the cell 100A-1 and the beam 3 of the cell 100B-1 may be a source of inter-cell interference for the terminal 104. Alternatively, the base station 100 may determine time information corresponding to the interference based on the inter-cell interference measurement result. The base station 100 can further determine that the neighboring cells 100A-1 and 100B-1 are using the beam 2 and the beam 3 respectively at the corresponding time based on the beam usage of the neighboring cells 100A-1 and 100B-1. Likewise, the base station 100 may determine/infer that one or both of the beam 2 and the beam 3 may be a source of inter-cell interference for the terminal 104.

In the example of Table c, time-frequency resources used by base stations 100A and 100B when base station 100 measures inter-cell interference are repeated in the same period as the time-frequency resources of base station 100, and beam combinations of the three cells are the same in different periods. Therefore, the interference measurement results can be determined based on either a single interference measurement (for example, operation 1 or operation 4) or base on multiple interference measurements (for example, considering both operation 1 and operation 4). In an embodiment, the base station 100 can obtain the beam usage of a neighboring cell before or after obtaining inter-cell interference measurement results.

In the example of Table d, the process of determining the source of inter-cell interference for the terminal 104 is similar to that of Table c. In Table d, the time-frequency resources used by at least one neighboring cell (i.e., cell 100B) when the base station 100 measures inter-cell interference are random, and beam combinations of the three cells are different in different periods. Therefore, in this example, it is necessary to determine interference measurement results based on any single interference measurement (for example, operation 1, operation 3, or operation 4). Different beam combinations can result the determined/inferred interference source more accurate. For example, since in both measurement operation 1 and measurement operation 4 where inter-cell interferences were measured, cell 100B has used different beam 1 and beam 4, while cell 100A has used the same beam 2, it can be determined/inferred that the beam 2 of cell 100A-1 is the source of interference. In general, there is only one interference beam for a specific terminal. Therefore, it can be further inferred that other beams (for example, beam 1) of the cell 100A-1 are not interference beams for the terminal 104. Based again on measurement operation 3, since beam 1 of cell 100A-1 is not an interference beam for terminal 104, beam 3 of cell 100B-1 is determined to be an interference beam for terminal 104.

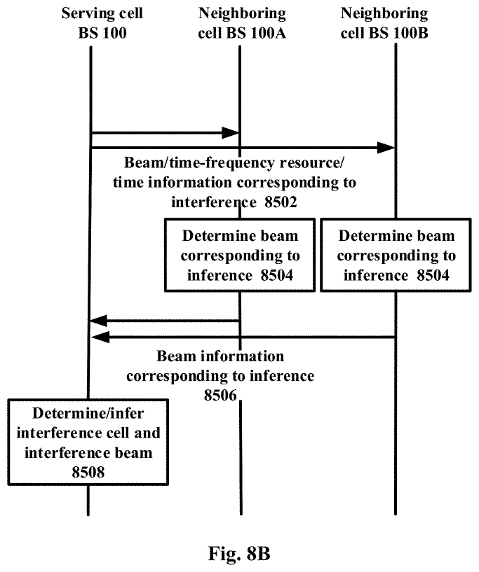

FIGS. 8A and 8B illustrate signaling operations between a base station of a serving cell and a base station of a neighboring cell according to an embodiment. In the example of FIG. 8A, at 8002, base stations 100A and 100B of neighboring cells transmit beam usage information of the neighboring cells to a base station 100 of the serving cell, respectively. As mentioned above, the operation at 8002 can be performed before the base station 100 of the serving cell obtains inter-cell interference measurement result or at any appropriate time. At 8004, the base station 100 of the serving cell can determine/infer the interfering cell and the interfering beam, for example, based on the above operations described with reference to FIGS. 7A and 7B.

The example operation in FIG. 8B is generally performed after the base station of the serving cell obtains the inter-cell interference measurement result. In the example of FIG. 8B, at 8052, the base station 100 of the serving cell may determine at least one of the beam, time-frequency resource, or time information corresponding to the interference in the interference measurement result, and transmit it to base station of each neighboring cell. The time information can be characterized as a slot index and/or a symbol index. At 8504, base station of each neighboring cell can receive at least one of the beam, time-frequency resource, or time information corresponding to the neighboring cell interference measured by the serving cell, and determine the beam of the present cell corresponding to the interference. At 8506, base station of each neighboring cell can transmit interference beam information to the base station of the serving cell. The interference beam information may include one or more downlink beams of one or more neighboring cells corresponding to at least one of the above beams, time-frequency resources, or time information. At 8508, the base station of the serving cell can further determine/infer the interference cell and the interference beam.

### Parallel Inter-Cell Interference Measurement and Beam Tracking

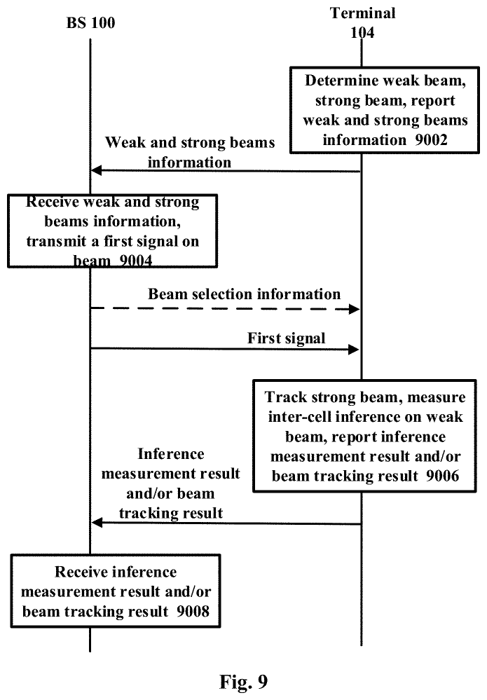

FIG. 9 illustrates an example process between a base station and a terminal for measuring inter-cell interference and tracking beams according to an embodiment. This example process can be executed by the electronic device 300 and the electronic device 350 described above.

In FIG. 9, the base station 100 is a serving cell base station of the terminal 104. As illustrated in FIG. 9, at 9002, the terminal 104 may determine one or more downlink weak beams and strong beams of the serving cell, for example, by the aforementioned threshold comparison method. The terminal 104 may also transmit information on one or more weak beams and/or strong beams for the terminal 104 to the base station 100 of the serving cell, for example, in the form of a report in FIG. 5B.

At 9004, the base station 100 can receive information on strong and weak beams. Based on the information on strong and weak beams, the base station 100 can know which beam(s) of the serving cell is/are strong beam(s) and which beam(s) is/are weak beam(s) for the terminal 104. The base station 100 may transmit a first signal to different terminals on respective beams, where the first signal to the terminal 104 is transmitted on a strong beam for the terminal 104.

At 9006, when different beams are used, the terminal 104 can perform different operations. In an embodiment, when a strong beam for the terminal 104 is used, the terminal 104 can track the strong beam, and when a weak beam for the terminal 104 is used, the terminal 104 can use the occasion when the weak beam is used to measure cell interferences. Next, the terminal 104 may transmit interference measurement results and/or beam tracking results to the base station 100, for example, in the form of a report in FIG. 7C.

At 9008, the base station 100 may receive interference measurement results and/or beam tracking results. It is easy to understand that in the embodiment where inter-cell interference measurement and beam tracking are performed in parallel, time-frequency resources corresponding to each downlink beam of a base station are fully utilized. In a single resource period, a specific terminal can complete both inter-cell interference measurement and beam tracking, and it does not need multiple resource periods to perform inter-cell interference measurement and beam tracking separately, which improves time efficiency. Moreover, in a single resource period, each beam and its corresponding time-frequency resource can be used both for beam tracking by, for example, the directed terminal, and for measuring inter-cell interferences by other terminals (for example, uncovered terminals), which improves utilization of time-frequency resources.

In some embodiments, in the example processing of FIG. 9, after receiving the information on strong and weak beams, the base station 100 may transmit beam selection information to the terminal 104. In one embodiment, the beam selection information may include information on a subset of one or more weak beams for the terminal 104, so that the terminal 104 can measure interferences from one or more neighboring cells when weak beams of the subset are used to transmit a first signal. For example, the beams in the subset are the weakest beam or beams for the terminal 104. Or, the beams in the subset may be selected based on beams of the neighboring cells that are desired to be measured. In scenario a of FIG. 7A, if the base station 100 desires to measure the beam 3 of the neighboring cell 100A-1, and the base station 100 can determine, based on at least one of the beam, time-frequency resource, or time information of the beam 3, that the corresponding beam in the serving cell 100-1 is beam 2, then the subset of beams can include the beam 2.

In one embodiment, similarly, beam selection information may include information on a subset of one or more strong beams for the terminal 104, so that the terminal 104 can track the performance of the strong beams when strong beams of the subset are used to transmit downlink signals.

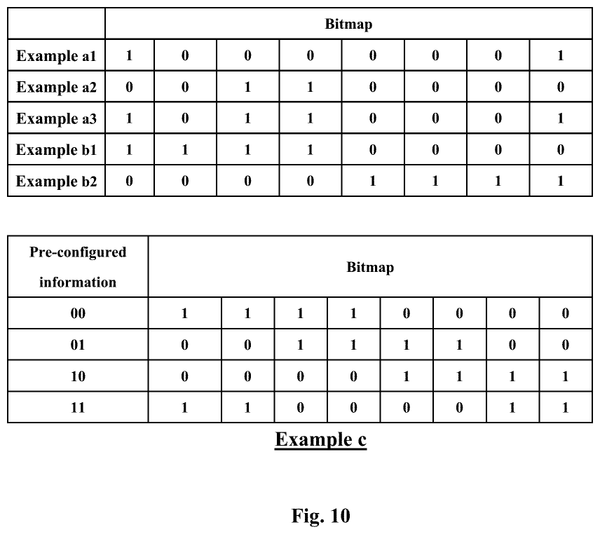

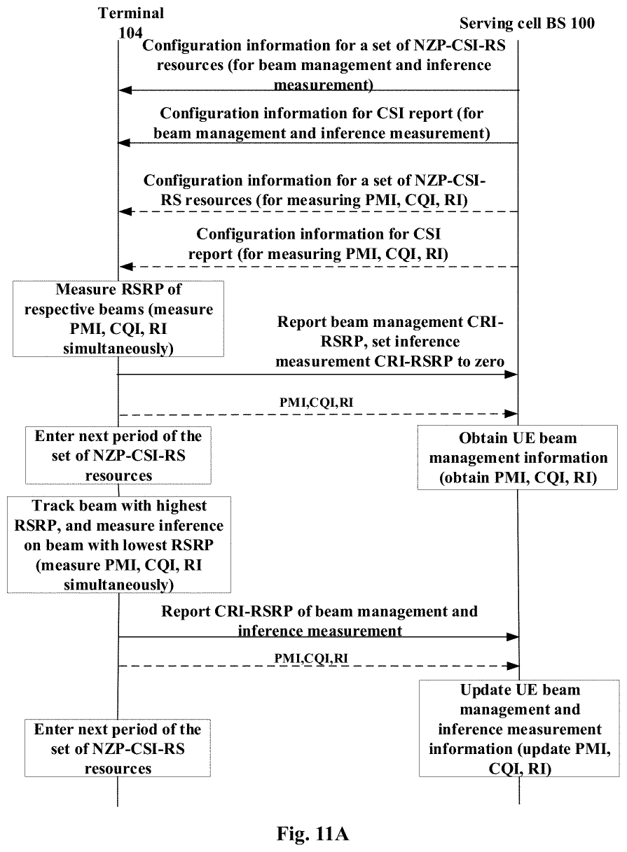

In an embodiment, the beam selection information may be transmitted and received by downlink control information (DCI). For example, DCI may be transmitted once every one or more resource periods to update beam selection information. An example form of beam selection information is described below in connection with FIG. 10.

In FIG. 10, referring to the beam strength measurement results in FIG. 2, that is, for the terminal 104, the strengths of beams 1 to 8 are: weak, weak, strong, stronger, strong, stronger, weak, weak, and in that order. Without control by beam selection information, the terminal 104 may measure inter-cell interferences when beams 1, 2, 7, and 8 are used, and may perform beam tracking when beams 3 to 6 are used. In some embodiments, the beam selection information may be represented by a bitmap with a plurality of bits corresponding to a plurality of downlink beams, and each bit indicating whether a corresponding downlink beam belongs to a subset of strong or weak beams.

In one approach, each bit in the bitmap can directly represent whether corresponding beam belongs to a subset of strong and weak beams. In the example a1 of FIG. 10, the bit value 1 represents that the beams 1 and 8 belong to the subset of weak beams, and the terminal 104 can measure inter-cell interferences only when the beams 1 and 8 are used. In the example a2 of FIG. 10, the bit value 1 represents that the beams 3 and 4 belong to the subset of strong beams, and the terminal 104 may only track the beams 3 and 4. The information in example a1 and example a2 in FIG. 10 can be formed together, as shown in example a3.

In one approach, each bit in the bitmap can indicate whether the corresponding beam is activated, and only the activated beam may belong to a subset of strong and weak beams. In the example b1 of FIG. 10, a bit value of 1 represents that beams 1 to 4 are beams that are enabled for the terminal 104 with respect to inter-cell interference measurement and beam tracking. Considering the strength of beams 1 to 4, the terminal 104 can measure inter-cell interferences only when the beams 1 and 2 are used, and the terminal 104 can track the beams 3 and 4. Similarly, in the example b2 of FIG. 10, the terminal 104 can measure inter-cell interferences only when the beams 7 and 8 are used, and the terminal 104 can track the beams 5 and 6.

In some embodiments, considering that a bitmap may include more bits, corresponding pre-configured information may be specified for each bitmap, and the pre-configured information generally has fewer bits. Example c of FIG. 10 illustrates the correspondence between the pre-configured information and the bitmap. In this way, the pre-configured information can also correspond to a particular subset of strong and weak beams, and transmission of this pre-configured information between a base station and a terminal can save signaling overhead.

### Exemplary Use Cases

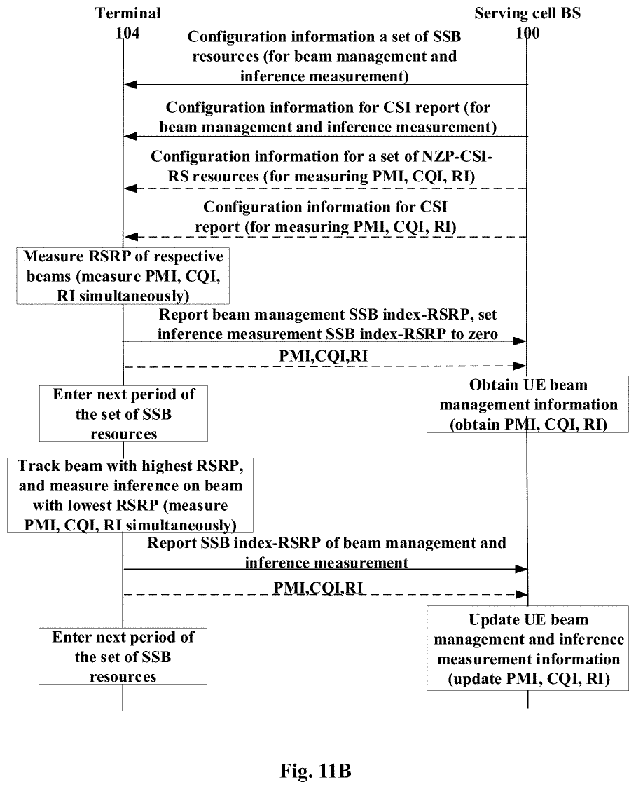

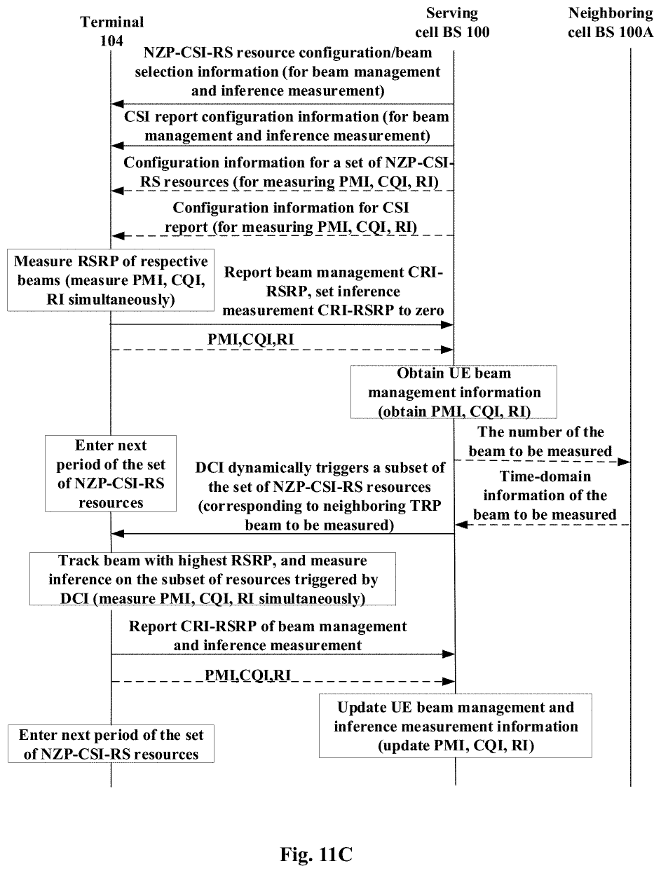

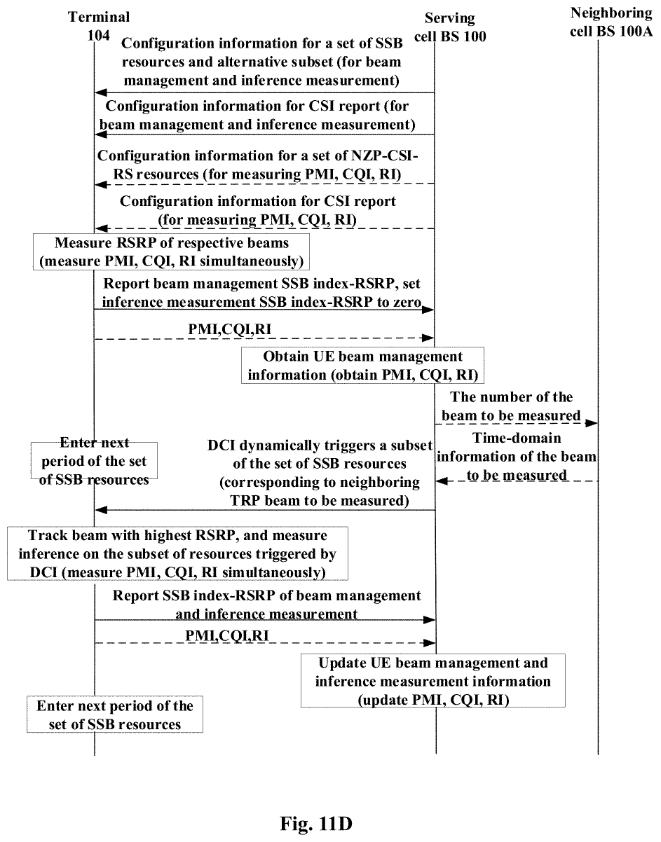

Hereinafter, an exemplary use case of the solution according to the present disclosure in a 5G NR system will be described in connection with FIGS. 11A to 11D. This example process can be executed by the electronic device 300 and the electronic device 350 described above. In FIG. 11A and FIG. 11D, the base station 100 is a serving cell base station of the terminal 104.

FIGS. 11A and 11B illustrate use cases of parallel inter-cell interference measurement and beam management (i.e., beam tracking). In the first stage, the terminal 104 measures each downlink beam of a serving cell, and the base station 100 obtains beam management information accordingly. Specifically, the base station 100 can configure a set of periodic NZP-CSI-RS resources for the terminal 104 for parallel beam management and interference measurement through, for example, RRC signaling. The base station 100 can also configure a CSI report corresponding to the set of NZP-CSI-RS resources (for example, with the format in FIG. 5B). For example, CSI reports for beam management (CRI-RSRP for feeding back strong beams) and CSI reports for interference measurement (CRI-RSRP for feeding back interference measurement) can be configured respectively. Optionally, the number of CRI-RSRP to be fed back in each CSI report can be configured. For example, the terminal 104 can feed back a specified number of CRI-RSRP(s) of maximum RSRP for beam management, and feed back a specified number of CRI-RSRP(s) of maximum RSRP for interference measurement.

It should be understood that the aforementioned set of NZP-CSI-RS resources is a CSI-RS used for analog beam management, which is different from the set of NZP-CSI-RS resources used for obtaining digital baseband CSI (including PMI, CQI, and RI). In some embodiments, another set of NZP-CSI-RS resources can be configured to obtain the digital baseband channel state (as shown in the figures by the dashed line signaling, in various figures herein, the dashed line indicates optional operations).

The first stage can correspond to the set of NZP-CSI-RS resources of the first or previous periods, and the terminal 104 can distinguish the beam with the highest RSRP (for beam management) and the beam with weaker RSRP (for inter-cell interference measurement) through measurement, and can feed back to the base station 100 through a CSI report. In the first stage, when the CRI-RSRP for beam management is fed back, the content of the report for interference measurement can be set to zero. Next, the base station 100 can obtain beam management information of the terminal 104. Optionally, the terminal 104 can feed back to the base station 100 channel state information such as PMI, CQI, and RI, measured on corresponding NZP-CSI-RS resources.

The subsequent set of NZP-CSI-RS resources period may correspond to the second stage. In the second stage, the terminal 104 can track high RSRP beams on NZP-CSI-RS resources corresponding to high RSRP beams to implement beam management, and measure interferences on low RSRP beams at the same time, and transmit corresponding CRI reports to the base station 100. The terminal 104 may also update the high RSRP beams and the low RSRP beams after the end of each resource period. The base station 100 may update the beam management information and interference measurement information of the terminal 104 after receiving the CSI report. Optionally, the base station 100 may also communicate with base stations of neighboring cells to determine interference cells and interference beams. Optionally, the terminal 104 may update the base station 100 with channel state information such as PMI, CQI, and RI, measured on corresponding NZP-CSI-RS resources. After that, the process of the second stage can be repeated.

The set of NZP-CSI-RS resources for beam management and interference measurement in FIG. 11A can be replaced with a set of SSB resources, as shown in FIG. 11B. Similar to the set of NZP-CSI-RS resources, the set of SSB resources has periodicity, and each of SSB resource corresponds to one downlink beam of a serving cell, and the terminal 104 can measure the RSRP of each SSB. The example of FIG. 11B can be understood with reference to the description of FIG. 11A. Wherein, the channel state information is still obtained through corresponding NZP-CSI-RS.

FIGS. 11C and 11D illustrate further use cases of parallel inter-cell interference measurement and beam management. The use cases of FIGS. 11C and 11D can correspond to FIGS. 11A and 11B, respectively. Compared with FIGS. 11A and 11B, the use cases of FIGS. 11C and 11D include dynamic control of beam management and interference measurement, for example, based on the beam selection information in FIG. 10. In the process of the second stage of FIGS. 11C and 11D, in at least one resource period, the base station 100 may transmit beam selection information to the terminal 104 through, for example, DCI signaling, so as to select/update the subset of weak beams for measuring inter-cell interference. In one embodiment, the base station 100 can transmit beams of neighboring cells that the base station 100 desires to measure, to the base station 100A of the neighboring cell, and the base station of the neighboring cell can feed back time domain information of the beams of the neighboring cells to the base station 100. Then, the base station 100 may select a weak beam for measuring the beams of the neighboring cells for the terminal 104 based on the time domain information of the beams of the neighboring cells. Next, the terminal 104 can measure inter-cell interferences only when the selected weak beam is used. The further details of FIGS. 11C and 11D can be understood with reference to the description of FIGS. 11A and 11B.

### Exemplary Methods

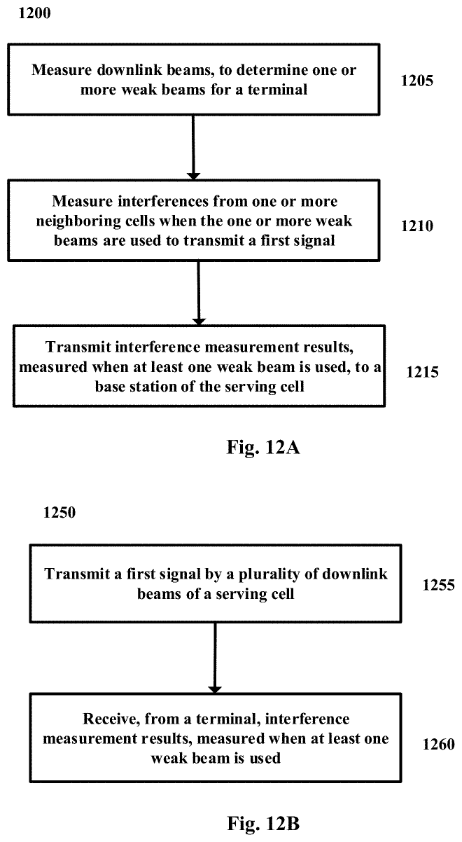

FIG. 12A illustrates an example method for communication according to an embodiment. As illustrated in FIG. 12A, the method 1200 can comprise measuring a plurality of downlink beams of a serving cell, to determine one or more weak beams from the plurality of downlink beams for a terminal (block 1205); measuring interferences from one or more neighboring cells when the one or more weak beams are used to transmit a first signal (block 1210). The method 1200 can further comprise transmitting interference measurement results, measured when at least one weak beam is used, to a base station of the serving cell (block 1215). The method may be executed by the electronic device 300, and the detailed example operations of the method may be referenced to the above description of the operations and functions of the electronic device 300, which are briefly described as follows.

In one embodiment, the first signal is of non-zero power and the first signal comprises at least one of a downlink reference signal or a synchronization signal block.

In one embodiment, the first signal on each of the plurality of downlink beams corresponds to specific time-frequency resources, and the interference measurement results, measured when the at least one weak beam is used, are transmitted along with an indication of time-frequency resources for the first signal on the at least one weak beam or with a beam ID of the at least one weak beam.

In one embodiment, determining the one or more weak beams for the terminal comprises: determining, a downlink beam with received signal to interference and noise ratio (SINR) or a received power lower than a threshold for the terminal, as a weak beam for the terminal.

In one embodiment, the one or more weak beams for the terminal are determined based on a single measurement result of each of the plurality of downlink beams, or based on statistics for multiple measurement results of each of the plurality of downlink beams.

In one embodiment, the interference measurement results are based on a single interference measurement result or statistics for multiple interference measurement results.

In one embodiment, the interference measurement results, measured when the at least one weak beam is used, are transmitted in a channel state information (CSI) report.

In one embodiment, the method further comprises: transmitting, to the base station, information on the one or more weak beams for the terminal; receiving, from the base station, information on a subset of the one or more weak beams; and measuring interferences from one or more neighboring cells when a weak beam of the subset is used to transmit the first signal.

In one embodiment, the information on the subset is received by downlink control information, and the information on the subset is received by at least one of the following: a bitmap with a plurality of bits corresponding to the plurality of downlink beams, and each bit indicating whether a corresponding downlink beam belongs to the subset; or pre-configured information corresponding to a particular subset of weak beams.

In one embodiment, the method further comprises: measuring, by the first signal, the plurality of downlink beams of the serving cell, to determine one or more strong beams from the plurality of downlink beams for the terminal; and performing beam management by using the one or more strong beams.

FIG. 12B illustrates another example method for communication according to an embodiment of the present disclosure. As illustrated in FIG. 12B, the method 1250 can comprise transmitting a first signal by a plurality of downlink beams of a serving cell (block 1255). The method 1250 can further comprise receiving, from a terminal, interference measurement results, measured when at least one weak beam is used (block 1260), wherein, the interference measurement results are obtained by the terminal by measuring interferences from one or more neighboring cells when one or more weak beams for the terminal are used to transmit the first signal. The method may be executed by the electronic device 350, and detailed example operations of the method may be referenced to the above description of the operations and functions of the electronic device 350, which are briefly described as follows.

In one embodiment, the first signal is non-zero power and the first signal comprises at least one of a downlink reference signal or a synchronization signal block.

In one embodiment, the first signal on each of the plurality of downlink beams of the serving cell corresponds to specific time-frequency resources, and the interference measurement results, measured when the at least one weak beam is used, are transmitted along with an indication of time-frequency resources for the first signal on the at least one weak beam or with a beam ID of the at least one weak beam.

In one embodiment, the one or more weak beams for the terminal comprise a downlink beam with received signal to interference and noise ratio (SINR) or a received power lower than a threshold for the terminal.

In one embodiment, receiving the interference measurement results, measured when at least one weak beam is used, from the terminal comprises: receiving the interference measurement results, measured when the at least one weak beam is used, in a channel state information (CSI) report.

In one embodiment, the method further comprises: receiving, from the terminal, information on one or more weak beams for the terminal; transmitting, to the terminal, information on a subset of the one or more weak beams, for the terminal to measure interferences from one or more neighboring cells when a weak beam of the subset is used to transmit the first signal.

In one embodiment, the information on the subset is transmitted by downlink control information, and the information on the subset is transmitted by at least one of the following: a bitmap with a plurality of bits corresponding to the plurality of downlink beams, and each bit indicating whether a corresponding downlink beam belongs to the subset; or pre-configured information corresponding to a particular subset of weak beams.

In one embodiment, the method further comprises communicating with the one or more neighboring cells to determine one or more downlink beams of the one or more neighboring cells that interfere with the terminal.

In one embodiment, communicating with the one or more neighboring cells comprises: determining time information corresponding to the interference in the interference measurement results; transmitting, to the one or more neighboring cells, the time information; and receiving, from the one or more neighboring cells, interference beam information including one or more downlink beams of the one or more neighboring cells corresponding to the time information.

In one embodiment, the time information is characterized as a slot index and a symbol index.

In one embodiment, the method further comprises: determining one or more downlink beams of the one or more neighboring cells with interferences based on the interference beam information in a certain period of time.

In one embodiment, the method further comprises: receiving, from the one or more neighboring cells, time information corresponding to the neighbor cell interferences measured by each neighboring cell; and transmitting, to the one or more neighboring cells, interference beam information including one or more downlink beams of the serving cell corresponding to the time information.

Various exemplary electronic devices and methods according to embodiments of the present disclosure have been described above. It should be understood that the operations or functions of these electronic devices may be combined with each other to achieve more or less operations or functions than described. The operational steps of the methods can also be combined with each other in any suitable order, so that similarly more or fewer operations are achieved than described.

It should be understood that the machine-executable instructions in the machine-readable storage medium or program product according to the embodiments of the present disclosure can be configured to perform operations corresponding to the device and method embodiments described above. When referring to the above device and method embodiments, the embodiments of the machine-readable storage medium or the program product are clear to those skilled in the art, and therefore description thereof will not be repeated herein. A machine-readable storage media and a program product for carrying or including the above-described machine-executable instructions also fall within the scope of the present disclosure. Such storage medium can comprise, but is not limited to, a floppy disk, an optical disk, a magneto-optical disk, a memory card, a memory stick, and the like.

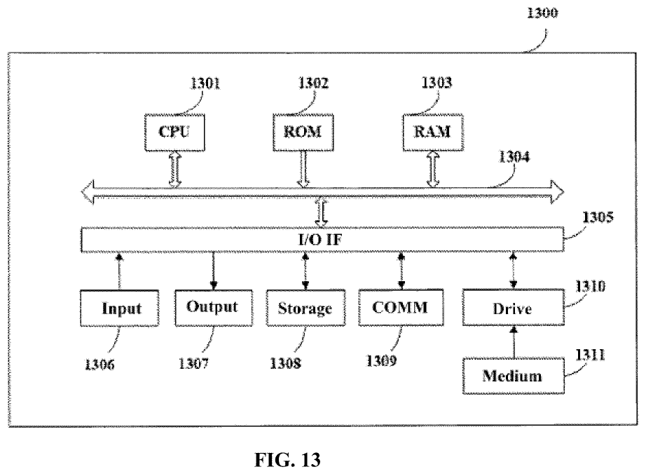

In addition, it should also be noted that the above series of processes and devices can also be implemented by software and/or firmware. In the case of being implemented by software and/or firmware, a program constituting the software is installed from a storage medium or a network to a computer having a dedicated hardware structure, such as the general-purpose personal computer 1300 shown in FIG. 13, which, when is installed with various programs, can execute various functions and so on. FIG. 13 is a block diagram showing an example structure of a personal computer which can be employed as an information processing device in the embodiment herein. In one example, the personal computer can correspond to the above-described exemplary terminal device in accordance with the present disclosure.

In FIG. 13, a central processing unit (CPU) 1301 executes various processes in accordance with a program stored in a read-only memory (ROM) 1302 or a program loaded from storage 1308 to a random access memory (RAM) 1303. In the RAM 1303, data required when the CPU 1301 executes various processes and the like is also stored as needed.

The CPU 1301, the ROM 1302, and the RAM 1303 are connected to each other via a bus 1304. Input/output interface 1305 is also connected to bus 1304.

The following components are connected to the input/output interface 1305: an input unit 1306 including a keyboard, a mouse, etc.; an output unit 1307 including a display such as a cathode ray tube (CRT), a liquid crystal display (LCD), etc., and a speaker, etc.; the storage 1308 including a hard disk etc.; and a communication unit 1309 including a network interface card such as a LAN card, a modem, etc. The communication unit 1309 performs communication processing via a network such as the Internet.

The driver 1310 is also connected to the input/output interface 1305 as needed. A removable medium 1311 such as a magnetic disk, an optical disk, a magneto-optical disk, a semiconductor memory or the like is mounted on the drive 1310 as needed, so that a computer program read therefrom is installed into the storage 1308 as needed.

In the case where the above-described series of processing is implemented by software, a program constituting the software is installed from a network such as the Internet or a storage medium such as the removable medium 1311.

It will be understood by those skilled in the art that such a storage medium is not limited to the removable medium 1311 shown in FIG. 13 in which a program is stored and distributed separately from the device to provide a program to the user. Examples of the removable medium 1311 include a magnetic disk (including a floppy disk (registered trademark)), an optical disk (including a compact disk read only memory (CD-ROM) and a digital versatile disk (DVD)), a magneto-optical disk (including a mini disk (MD) (registered trademark)) and a semiconductor memory. Alternatively, the storage medium may be a ROM 1302, a hard disk included in the storage section 1308, or the like, in which programs are stored, and distributed to users together with the device containing them.

The technology of the present disclosure can be applied to various products. For example, the base stations mentioned in this disclosure can be implemented as any type of evolved Node B (gNB), such as a macro gNB and a small gNB. The small gNB can be a gNB covering a cell smaller than the macro cell, such as a pico gNB, a micro gNB, and a home (femto) gNB. Alternatively, the base station can be implemented as any other type of base station, such as a NodeB and a Base Transceiver Station (BTS). The base station can include: a body (also referred to as a base station device) configured to control radio communication; and one or more remote radio heads (RRHs) disposed at a different location from the body. In addition, various types of terminals which will be described below can each operate as a base station by performing base station functions temporarily or semi-persistently.

For example, the terminal device mentioned in the present disclosure, also referred to as a user device in some examples, can be implemented as a mobile terminal (such as a smartphone, a tablet personal computer (PC), a notebook PC, a portable game terminal, a portable/dongle type mobile router and digital camera) or in-vehicle terminal (such as car navigation device). The user device may also be implemented as a terminal that performs machine-to-machine (M2M) communication (also referred to as a machine type communication (MTC) terminal). Further, the user device may be a radio communication module (such as an integrated circuit module including a single wafer) installed on each of the above terminals.

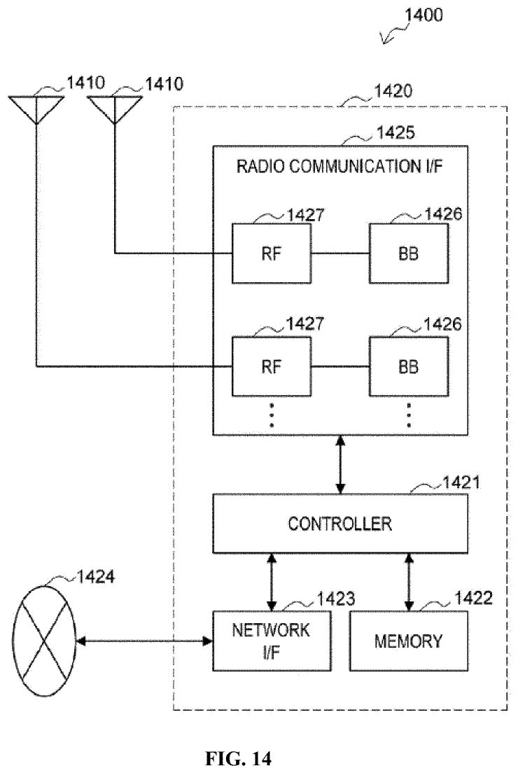

Use cases according to the present disclosure will be described below with reference to FIGS. 14 to 17.

### Use Cases for Base Stations

### First Use Case

FIG. 14 is a block diagram illustrating a first example of a schematic configuration of a gNB to which the technology of the present disclosure can be applied. The gNB 1400 includes a plurality of antennas 1410 and a base station device 1420. The base station device 1420 and each antenna 1410 may be connected to each other via an RF cable. In one implementation, the gNB 1400 (or base station device 1420) herein may correspond to the electronic devices 300A, 1300A, and/or 1500B described above.

Each of the antennas 1410 includes a single or multiple antenna elements (such as multiple antenna elements included in a Multiple Input and Multiple Output (MIMO) antenna), and is used for the base station device 1420 to transmit and receive radio signals. As shown in FIG. 14, the gNB 1400 may include multiple antennas 1410. For example, multiple antennas 1410 may be compatible with multiple frequency bands used by the gNB 1400.

The base station device 1420 includes a controller 1421, a memory 1422, a network interface 1423, and a radio communication interface 1425.

The controller 1421 may be, for example, a CPU or a DSP, and operates various functions of higher layers of the base station device 1420. For example, controller 1421 generates data packets from data in signals processed by the radio communication interface 1425, and transfers the generated packets via network interface 1423. The controller 1421 can bundle data from multiple baseband processors to generate the bundled packets, and transfer the generated bundled packets. The controller 1421 may have logic functions of performing control such as radio resource control, radio bearer control, mobility management, admission control, and scheduling. This control may be performed in corporation with a gNB or a core network node in the vicinity. The memory 1422 includes RAM and ROM, and stores a program that is executed by the controller 1421 and various types of control data such as a terminal list, transmission power data, and scheduling data.

The network interface 1423 is a communication interface for connecting the base station device 1420 to the core network 1424. Controller 1421 may communicate with a core network node or another gNB via the network interface 1423. In this case, the gNB 1400 and the core network node or other gNBs may be connected to each other through a logical interface such as an S1 interface and an X2 interface. The network interface 1423 may also be a wired communication interface or a radio communication interface for radio backhaul lines. If the network interface 1423 is a radio communication interface, the network interface 1423 may use a higher frequency band for radio communication than a frequency band used by the radio communication interface 1425.

The radio communication interface 1425 supports any cellular communication schemes, such as Long Term Evolution (LTE) and LTE-Advanced, and provides radio connection to a terminal positioned in a cell of the gNB 1400 via the antenna 1410. Radio communication interface 1425 may typically include, for example, a baseband (BB) processor 1426 and a RF circuit 1427. The BB processor 1426 may perform, for example, encoding/decoding, modulation/demodulation, and multiplexing/demultiplexing, and performs various types of signal processing of layers such as L1, Medium Access Control (MAC), Radio Link Control (RLC), and Packet Data Convergence Protocol (PDCP). Instead of controller 1421, the BB processor 1426 may have a part or all of the above-described logic functions. The BB processor 1426 may be a memory that stores a communication control program, or a module that includes a processor configured to execute the program and a related circuit. Updating the program may allow the functions of the BB processor 1426 to be changed. The module may be a card or a blade that is inserted into a slot of the base station device 1420. Alternatively, the module may also be a chip that is mounted on the card or the blade. Meanwhile, the RF circuit 1427 may include, for example, a mixer, a filter, and an amplifier, and transmits and receives radio signals via the antenna 1410. Although FIG. 14 illustrates an example in which one RF circuit 1427 is connected to one antenna 1410, the present disclosure is not limited to thereto; rather, one RF circuit 1427 may connect to a plurality of antennas 1410 at the same time.

As illustrated in FIG. 14, the radio communication interface 1425 may include the multiple BB processors 1426. For example, the multiple BB processors 1426 may be compatible with multiple frequency bands used by gNB 1400. As illustrated in FIG. 14, the radio communication interface 1425 may include the multiple RF circuits 1427. For example, the multiple RF circuits 1427 may be compatible with multiple antenna elements. Although FIG. 14 illustrates the example in which the radio communication interface 1425 includes the multiple BB processors 1426 and the multiple RF circuits 1427, the radio communication interface 1425 may also include a single BB processor 1426 or a single RF circuit 1427.

### Second Use Case

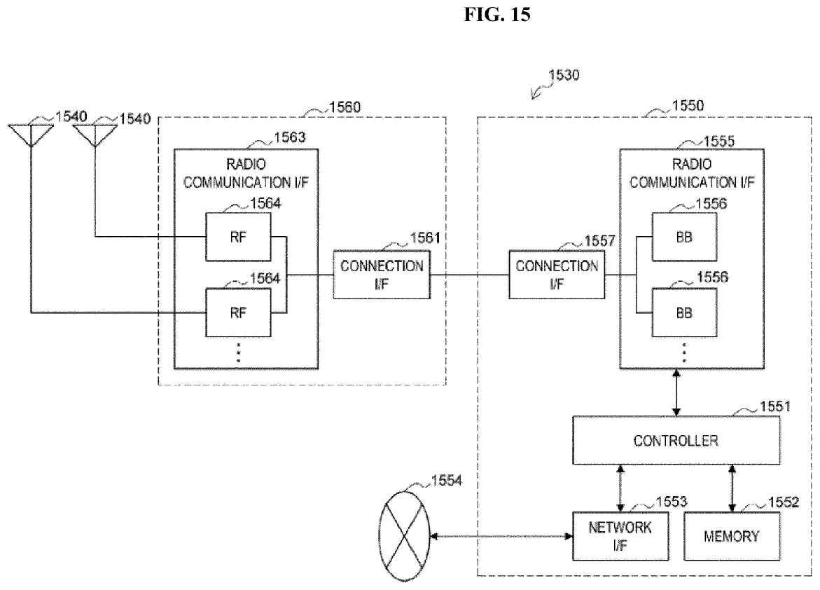

FIG. 15 is a block diagram illustrating a second example of a schematic configuration of a gNB to which the technology of the present disclosure may be applied. The gNB 1530 includes a plurality of antennas 1540, a base station device 1550, and an RRH 1560. The RRH 1560 and each antenna 1540 may be connected to each other via an RF cable. The base station device 1550 and the RRH 1560 may be connected to each other via a high speed line such as a fiber optic cable. In one implementation, the gNB 1530 (or base station device 1550) herein may correspond to the electronic devices 300A, 1300A, and/or 1500B described above.

Each of the antennas 1540 includes a single or multiple antenna elements such as multiple antenna elements included in a MIMO antenna and is used for the RRH 1560 to transmit and receive radio signals. The gNB 1530 may include multiple antennas 1540, as illustrated in FIG. 15. For example, multiple antennas 1540 may be compatible with multiple frequency bands used by the gNB 1530.

The base station device 1550 includes a controller 1551, a memory 1552, a network interface 1553, a radio communication interface 1555, and a connection interface 1557. The controller 1551, the memory 1552, and the network interface 1553 are the same as the controller 1421, the memory 1422, and the network interface 1423 described with reference to FIG. 14.

The radio communication interface 1555 supports any cellular communication scheme (such as LTE and LTE-Advanced) and provides radio communication to terminals positioned in a sector corresponding to the RRH 1560 via the RRH 1560 and the antenna 1540. The radio communication interface 1555 may typically include, for example, a BB processor 1556. The BB processor 1556 is the same as the BB processor 1426 described with reference to FIG. 14, except that the BB processor 1556 is connected to the RF circuit 1564 of the RRH 1560 via the connection interface 1557. The radio communication interface 1555 may include the multiple BB processors 1556, as illustrated in FIG. 15. For example, the multiple BB processors 1556 may be compatible with multiple frequency bands used by the gNB 1530. Although FIG. 15 illustrates the example in which the radio communication interface 1555 includes multiple BB processors 1556, the radio communication interface 1555 may also include a single BB processor 1556.

The connection interface 1557 is an interface for connecting the base station device 1550 (radio communication interface 1555) to the RRH 1560. The connection interface 1557 may also be a communication module for communication in the above-described high speed line that connects the base station device 1550 (radio communication interface 1555) to the RRH 1560.

The RRH 1560 includes a connection interface 1561 and a radio communication interface 1563.

The connection interface 1561 is an interface for connecting the RRH 1560 (radio communication interface 1563) to the base station device 1550. The connection interface 1561 may also be a communication module for communication in the above-described high speed line.

The radio communication interface 1563 transmits and receives radio signals via the antenna 1540. Radio communication interface 1563 may typically include, for example, the RF circuitry 1564. The RF circuit 1564 may include, for example, a mixer, a filter, and an amplifier, and transmits and receives radio signals via the antenna 1540. Although FIG. 15 illustrates the example in which one RF circuit 1564 is connected to one antenna 1540, the present disclosure is not limited to thereto; rather, one RF circuit 1564 may connect to a plurality of antennas 1540 at the same time.

The radio communication interface 1563 may include multiple RF circuits 1564, as illustrated in FIG. 15. For example, multiple RF circuits 1564 may support multiple antenna elements. Although FIG. 15 illustrates the example in which the radio communication interface 1563 includes the multiple RF circuits 1564, the radio communication interface 1563 may also include a single RF circuit 1564.

### Use Cases Related to User Devices

### First Use Case

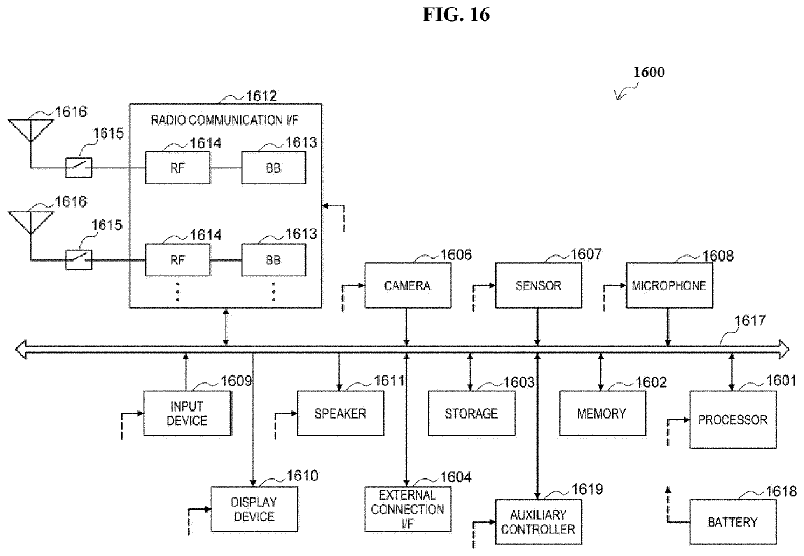

FIG. 16 is a block diagram illustrating an example of a schematic configuration of a smartphone 1600 to which the technology of the present disclosure may be applied. The smartphone 1600 includes a processor 1601, a memory 1602, a storage 1603, an external connection interface 1604, an camera 1606, a sensor 1607, a microphone 1608, an input device 1609, a display device 1610, a speaker 1611, a radio communication interface 1612, one or more antenna switch 1615, one or more antennas 1616, a bus 1617, a battery 1618, and an auxiliary controller 1619. In one implementation, smartphone 1600 (or processor 1601) herein may correspond to terminal device 300B and/or 1500A described above.

The processor 1601 may be, for example, a CPU or a system on chip (SoC), and controls functions of an application layer and the other layers of the smartphone 1600. The memory 1602 includes RAM and ROM, and stores a program that is executed by the processor 1601, and data. The storage 1603 may include a storage medium such as a semiconductor memory and a hard disk. The external connection interface 1604 is an interface for connecting an external device such as a memory card and a universal serial bus (USB) device to the smartphone 1600.

The camera 1606 includes an image sensor such as a charge coupled device (CCD) and a complementary metal oxide semiconductor (CMOS), and generates a captured image. Sensor 1607 may include a group of sensors such as a measurement sensor, a gyro sensor, a geomagnetic sensor, and an acceleration sensor. The microphone 1608 converts the sounds that are input to the smartphone 1600 to audio signals. The input device 1609 includes, for example, a touch sensor configured to detect touch on a screen of the display device 1610, a keypad, a keyboard, a button, or a switch, and receives an operation or an information input from a user. The display device 1610 includes a screen such as a liquid crystal display (LCD) and an organic light emitting diode (OLED) display, and displays an output image of the smartphone 1600. The speaker 1611 converts audio signals that are output from the smartphone 1600 to sounds.

The radio communication interface 1612 supports any cellular communication scheme such as LTE and LTE-Advanced, and performs radio communication. The radio communication interface 1612 may typically include, for example, a BB processor 1613 and an RF circuitry 1614. The BB processor 1613 may perform, for example, encoding/decoding, modulation/demodulation, and multiplexing/demultiplexing, and performs various types of signal processing for radio communication. Meanwhile, the RF circuit 1614 may include, for example, a mixer, a filter, and an amplifier, and transmits and receives radio signals via the antenna 1616. The radio communication interface 1612 may be a one chip module that integrates the BB processor 1613 and the RF circuit 1614 thereon. The radio communication interface 1612 may include multiple BB processors 1613 and multiple RF circuits 1614, as illustrated in FIG. 16. Although FIG. 16 illustrates the example in which the radio communication interface 1612 includes multiple BB processors 1613 and multiple RF circuits 1614, the radio communication interface 1612 may also include a single BB processor 1613 or a single RF circuit 1614.

Furthermore, in addition to a cellular communication scheme, the radio communication interface 1612 may support additional type of radio communication schemes, such as short-range wireless communication schemes, a near field communication schemes, and a wireless local area network (LAN) scheme. In this case, the radio communication interface 1612 may include the BB processor 1613 and the RF circuitry 1614 for each radio communication scheme.

Each of the antenna switches 1615 switches connection destinations of the antenna 1616 among multiple circuits (such as circuits for different radio communication schemes) included in the radio communication interface 1612.

Each of the antennas 1616 includes a single or multiple antenna elements (such as multiple antenna elements included in a MIMO antenna) and is used for the radio communication interface 1612 to transmit and receive radio signals. The smartphone 1600 may include multiple antennas 1616, as illustrated in FIG. 16. Although FIG. 16 illustrates the example in which the smartphone 1600 includes multiple antennas 1616, the smartphone 1600 may also include a single antenna 1616.

Furthermore, the smartphone 1600 may include the antenna 1616 for each radio communication scheme. In this case, the antenna switch 1615 may be omitted from the configuration of the smartphone 1600.

The bus 1617 connects the processor 1601, the memory 1602, the storage 1603, the external connection interface 1604, the camera 1606, the sensor 1607, the microphone 1608, the input device 1609, the display device 1610, the speaker 1611, the radio communication interface 1612, and the auxiliary control 1619 to each other. The battery 1618 supplies power to blocks of the smartphone 1600 illustrated in FIG. 16 via feeder lines, which are partially shown as a dashed line in the figure. The auxiliary controller 1619 operates a minimum necessary function of the smartphone 1600, for example, in a sleep mode.

### Second Use Case

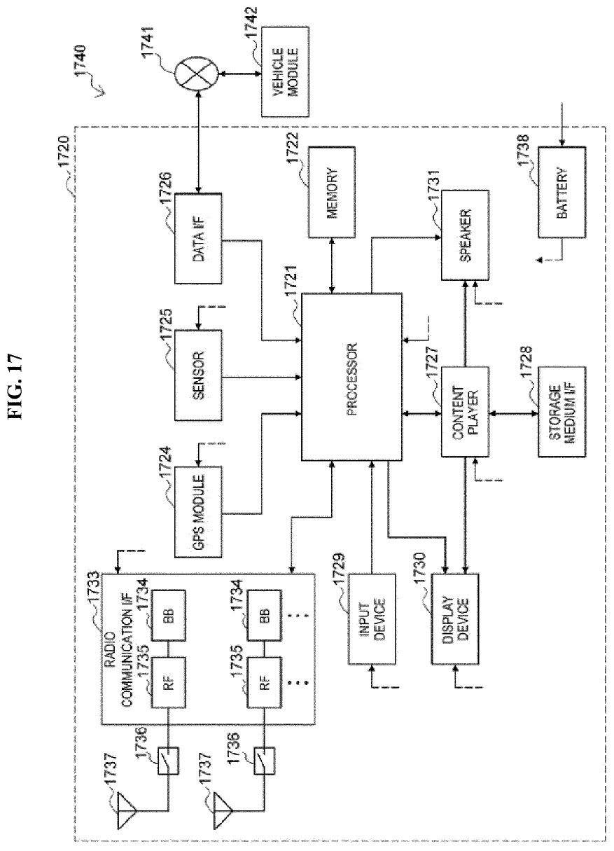

FIG. 17 is a block diagram illustrating an example of a schematic configuration of a car navigation device 1720 to which the technology of the present disclosure may be applied. The car navigation device 1720 includes a processor 1721, a memory 1722, a global positioning system (GPS) module 1724, a sensor 1725, a data interface 1726, a content player 1727, a storage medium interface 1728, an input device 1729, a display device 1730, a speaker 1731, and a radio communication interface 1733, one or more antenna switches 1736, one or more antennas 1737, and a battery 1738. In one implementation, car navigation device 1720 (or processor 1721) herein may correspond to terminal device 300B and/or 1500A described above.

The processor 1721 may be, for example, a CPU or a SoC, and controls a navigation function and other functions of the car navigation device 1720. The memory 1722 includes RAM and ROM, and stores a program that is executed by the processor 1721, and data.

The GPS module 1724 uses GPS signals received from a GPS satellite to measure a position, such as latitude, longitude, and altitude, of the car navigation device 1720. Sensor 1725 may include a group of sensors such as a gyro sensor, a geomagnetic sensor, and an air pressure sensor. The data interface 1726 is connected to, for example, an in-vehicle network 1741 via a terminal not shown, and acquires data generated by the vehicle, such as vehicle speed data.

The content player 1727 reproduces content stored in a storage medium (such as a CD and a DVD) that is inserted into the storage medium interface 1728. The input device 1729 includes, for example, a touch sensor configured to detect touch on a screen of the display device 1730, a button, or a switch, and receives an operation or an information input from a user. The display device 1730 includes a screen such as an LCD or an OLED display, and displays an image of the navigation function or content that is reproduced. The speaker 1731 outputs sounds of the navigation function or the content that is reproduced.

The radio communication interface 1733 supports any cellular communication scheme, such as LTE and LTE-Advanced, and performs radio communication. The radio communication interface 1733 may typically include, for example, a BB processor 1734 and an RF circuit 1735. The BB processor 1734 may perform, for example, encoding/decoding, modulation/demodulation, and multiplexing/demultiplexing, and performs various types of signal processing for radio communication. Meanwhile, the RF circuit 1735 may include, for example, a mixer, a filter, and an amplifier, and transmits and receives radio signals via the antenna 1737. The radio communication interface 1733 may also be a one chip module which integrates the BB processor 1734 and the RF circuit 1735 thereon. The radio communication interface 1733 may include multiple BB processors 1734 and multiple RF circuits 1735, as illustrated in FIG. 17. Although FIG. 17 illustrates the example in which the radio communication interface 1733 includes multiple BB processors 1734 and multiple RF circuits 1735, the radio communication interface 1733 may also include a single BB processor 1734 or a single RF circuit 1735.

Furthermore, in addition to a cellular communication scheme, the radio communication interface 1733 may support another type of radio communication scheme such as a short-range wireless communication scheme, a near-field communication scheme, and a wireless LAN scheme. In this case, the radio communication interface 1733 may include the BB processor 1734 and the RF circuit 1735 for each radio communication scheme.

Each of the antenna switches 1736 switches the connection destination of the antenna 1737 among multiple circuits (such as circuits for different radio communication schemes) included in the radio communication interface 1733.

Each of the antennas 1737 includes a single or multiple antenna elements, such as multiple antenna elements included in a MIMO antenna, and is used for the radio communication interface 1733 to transmit and receive radio signals. The car navigation device 1720 may include multiple antennas 1737, as illustrated in FIG. 17. Although FIG. 17 illustrates the example in which the car navigation device 1720 includes multiple antennas 1737, the car navigation device 1720 may also include a single antenna 1737.

Furthermore, the car navigation device 1720 may include the antenna 1737 for each radio communication scheme. In this case, the antenna switch 1736 may be omitted from the configuration of the car navigation device 1720.

The battery 1738 supplies power to blocks of the car navigation device 1720 illustrated in FIG. 17 via feeder lines that are partially shown as dashed lines in the figure. Battery 1738 accumulates power supplied from the vehicle.

The technology of the present disclosure may also be realized as an in-vehicle system (or vehicle) 1740 including one or more blocks of the car navigation device 1720, the in-vehicle network 1741, and the vehicle module 1742. The vehicle module 1742 generates vehicle data such as vehicle speed, engine speed, and faults information, and outputs the generated data to the in-vehicle network 1741.

The exemplary embodiments of the present disclosure have been described above with reference to the drawings, but the present disclosure is of course not limited to the above examples. Those skilled in the art can obtain various changes and modifications within the scope of the appended claims, and it should be understood that these changes and modifications will naturally fall within the technical scope of the present disclosure.

For example, a plurality of functions included in one unit in the above embodiments may be implemented by separate devices. Alternatively, the multiple functions implemented by the multiple units in the above embodiments may be implemented by separate devices, respectively. In addition, one of the above functions can be realized by multiple units. Needless to say, such a configuration is included in the technical scope of the present disclosure.

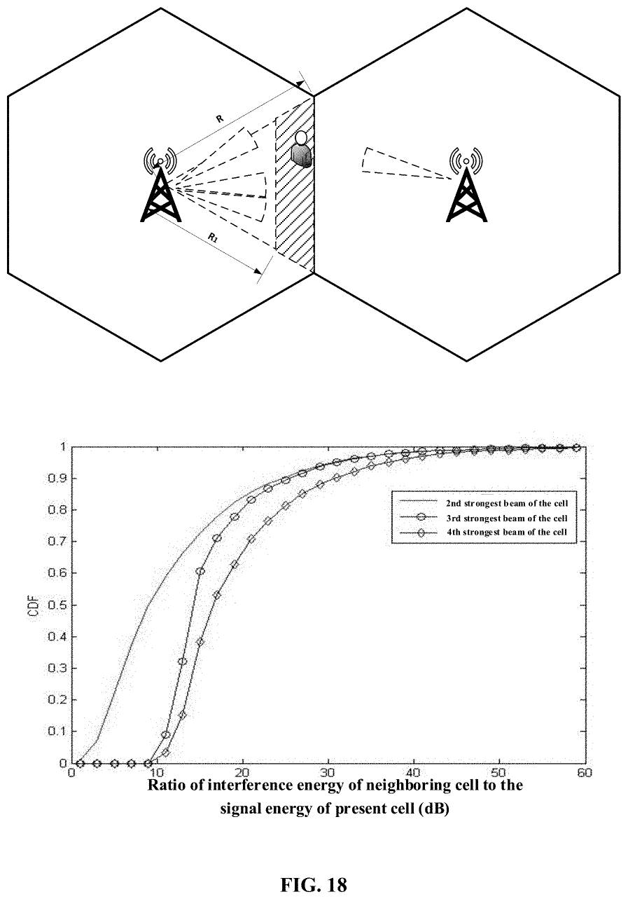

A simulation diagram of measuring beam strength according to the present disclosure will be described below with reference to FIG. 18. The simulation can show that, for most of beams of a serving cell, the RSSI caused thereof to a terminal at the edge of the cell is much smaller than the RSSI caused by the interference beams of neighboring cells, which can further show that most of the beams of the serving cell can be used for inter-cell interference measurement.

In the simulation, as shown in FIG. 18, considering two neighboring regular hexagon cells, the distance from the center of the regular hexagon to vertexes is R=100 m. Terminals are evenly distributed at the edge of the cell (the shaded area in the figure), wherein R₁=75 m. The carrier frequency is f_{c}=28 GHz. The numbers of base station antennas in the two cells are both Nₜ=64, and both adopt a DFT codebook as the beamforming codebook. Only the LOS path is considered here, and the path loss adopts the urban macro cell LOS model in TR38.900, that is,

PL(dB)=32.4+20 log₁₀d_{3D}+20 log₁₀f_{c},

Wherein, PL is the path loss, and the height difference between the terminal and the base station is taken as Δh=33.5 m to calculate the 3-dimensional space distance d_{3D} between the terminal and the base station.

The base station of the serving cell (the cell on the left) uses the second, third, and fourth strongest (that is, the three weakest) beams for the terminal's RSSI to transmit signals, while the neighboring cell (the cell on the right) uses the strongest beam (that is, corresponding to the beam with strongest interference) for the terminal's RSSI to transmit signals. The lower curve of FIG. 18 illustrates the CDF of the ratio of the inter-cell interference signal energy received by the terminal to the signal energy of the serving cell under the 3 weak beams of the serving cell.

It can be seen that, for the third and fourth strongest beams of the serving cell, the interference signal energy of the neighboring cell is at least 10 dB higher than the signal energy of the present cell. Therefore, as long as the serving cell does not use the first and second strong beams, the terminal can measure significant interference signals from the neighboring cell, so as to determine the interference beam. It can be seen from this that the two weakest beams can be used for inter-cell interference measurement.

Various example embodiments of the present disclosure may be implemented in the manner described in the following clauses:
Clause 1. An electronic device for a terminal side in a wireless communication system, comprising a processing circuit configured to:
   measure a plurality of downlink beams of a serving cell, to determine one or more weak beams from the plurality of downlink beams for the terminal;
   measure interferences from one or more neighboring cells when the one or more weak beams are used to transmit a first signal; and
   transmit interference measurement results, measured when at least one weak beam is used, to a base station of the serving cell.
Clause 2. The electronic device of clause 1, wherein the first signal is of non-zero power and the first signal comprises at least one of a downlink reference signal or a synchronization signal block (SSB).
Clause 3. The electronic device of clause 2, wherein the first signal on each of the plurality of downlink beams corresponds to specific time-frequency resources, and the interference measurement results, measured when the at least one weak beam is used, are transmitted along with an indication of time-frequency resources for the first signal on the at least one weak beam or with a beam ID of the at least one weak beam.
Clause 4. The electronic device of clause 1, wherein determining the one or more weak beams for the terminal comprises:
   determining, a downlink beam with received signal to interference and noise ratio (SINR) or a received power lower than a threshold for the terminal, as a weak beam for the terminal.
Clause 5. The electronic device of clause 4, wherein the one or more weak beams for the terminal are determined based on a single measurement result of each of the plurality of downlink beams, or based on statistics for multiple measurement results of each of the plurality of downlink beams.
Clause 6. The electronic device of clause 3, wherein the interference measurement results are based on a single interference measurement result or statistics for multiple interference measurement results.
Clause 7. The electronic device of clause 6, wherein the interference measurement results, measured when the at least one weak beam is used, are transmitted in a channel state information (CSI) report.
Clause 8. The electronic device of clause 1, wherein the processing circuit is further configured to:
   transmit, to the base station, information on the one or more weak beams for the terminal;
   receive, from the base station, information on a subset of the one or more weak beams; and
   measure interferences from one or more neighboring cells when a weak beam of the subset is used to transmit the first signal.
Clause 9. The electronic device of clause 8, wherein the information on the subset is received by downlink control information, and the information on the subset is received by at least one of the following:
   a bitmap with a plurality of bits corresponding to the plurality of downlink beams, and each bit indicating whether a corresponding downlink beam belongs to the subset; or
   pre-configured information corresponding to a particular subset of weak beams.
Clause 10. The electronic device of clause 1, wherein the processing circuit is further configured to:
   measure, by the first signal, the plurality of downlink beams of the serving cell, to determine one or more strong beams from the plurality of downlink beams for the terminal; and
   perform beam management by using the one or more strong beams.
Clause 11. An electronic device for a base station side in a wireless communication system, comprising a processing circuit configured to:
   transmit a first signal by a plurality of downlink beams of a serving cell; and
   receive interference measurement results, measured when at least one weak beam is used, from a terminal, wherein, the interference measurement results are obtained by the terminal by measuring interferences from one or more neighboring cells when one or more weak beams for the terminal are used to transmit the first signal.
Clause 12. The electronic device of clause 11, wherein the first signal is non-zero power and the first signal comprises at least one of a downlink reference signal or a synchronization signal block (SSB).
Clause 13. The electronic device of clause 12, wherein the first signal on each of the plurality of downlink beams of the serving cell corresponds to specific time-frequency resources, and the interference measurement results, measured when the at least one weak beam is used, are transmitted along with an indication of time-frequency resources for the first signal on the at least one weak beam or with a beam ID of the at least one weak beam.
Clause 14. The electronic device of clause 11, wherein the one or more weak beams for the terminal comprise a downlink beam with received signal to interference and noise ratio (SINR) or a received power lower than a threshold for the terminal.
Clause 15. The electronic device of clause 11, wherein receiving the interference measurement results, measured when at least one weak beam is used, from the terminal comprises:
   receiving the interference measurement results, measured when the at least one weak beam is used, in a channel state information (CSI) report.
Clause 16. The electronic device of clause 11, wherein the processing circuit is further configured to:
   receive, from the terminal, information on one or more weak beams for the terminal;
   transmit, to the terminal, information on a subset of the one or more weak beams, for the terminal to measure interferences from one or more neighboring cells when a weak beam of the subset is used to transmit the first signal.
Clause 17. The electronic device of clause 16, wherein the information on the subset is transmitted by downlink control information, and the information on the subset is transmitted by at least one of the following:
   a bitmap with a plurality of bits corresponding to the plurality of downlink beams, and each bit indicating whether a corresponding downlink beam belongs to the subset; or
   pre-configured information corresponding to a particular subset of weak beams.
Clause 18. The electronic device of clause 11, wherein the processing circuit is further configured to communicate with the one or more neighboring cells to determine one or more downlink beams of the one or more neighboring cells that interfere with the terminal.
Clause 19. The electronic device of clause 18, wherein communicating with the one or more neighboring cells comprises:
   determine the time information corresponding to the interference in the interference measurement result;
   determining time information corresponding to the interference in the interference measurement results;
   transmitting, to the one or more neighboring cells, the time information; and
   receiving, from the one or more neighboring cells, interference beam information including one or more downlink beams of the one or more neighboring cells corresponding to the time information.
Clause 20. The electronic device of clause 19, wherein the time information is characterized as a slot index and a symbol index.
Clause 21. The electronic device of clause 18, wherein the processing circuit is further configured to:
   determine one or more downlink beams of the one or more neighboring cells with interferences based on the interference beam information in a certain period of time.
Clause 22. The electronic device of clause 11, wherein the processing circuit is further configured to:
   receive, from the one or more neighboring cells, time information corresponding to the neighbor cell interferences measured by each neighboring cell; and
   transmit, to the one or more neighboring cells, interference beam information including one or more downlink beams of the serving cell corresponding to the time information.
Clause 23. A wireless communication method for a terminal side, comprising:
   measuring a plurality of downlink beams of a serving cell, to determine one or more weak beams from the plurality of downlink beams for the terminal;
   measuring interferences from one or more neighboring cells when the one or more weak beams are used to transmit a first signal; and
   transmitting interference measurement results, measured when at least one weak beam is used, to a base station of the serving cell.
Clause 24. A wireless communication method for a base station side, comprising:
   transmitting a first signal by a plurality of downlink beams of a serving cell; and
   receiving interference measurement results, measured when at least one weak beam is used, from a terminal, where the interference measurement results are obtained by the terminal by measuring interferences from one or more neighboring cells when one or more weak beams for the terminal are used to transmit the first signal.
Clause 25. A computer-readable storage medium storing one or more instructions that, when executed by one or more processors of an electronic device, cause the electronic device to perform methods as described in clauses 23 to 24.
Clause 26. A apparatus for use in a wireless communication system, comprising a unit for performing methods as described in clauses 23 to 24.

In this specification, the steps described in the flowchart include not only processes performed in time series in the described order, but also processes performed in parallel or individually rather than necessarily in time series. In addition, even in the steps processed in time series, needless to say, the order can be changed appropriately.

1. An electronic device for a terminal side in a wireless communication system, comprising a processing circuit configured to:
measure a plurality of downlink beams of a serving cell, to determine one or more weak beams from the plurality of downlink beams for the terminal;
measure interferences from one or more neighboring cells when the one or more weak beams are used to transmit a first signal; and
transmit interference measurement results, measured when at least one weak beam is used, to a base station of the serving cell.

2. The electronic device of claim 1, wherein the first signal is of non-zero power and the first signal comprises at least one of a downlink reference signal or a synchronization signal block (SSB).

3. The electronic device of claim 2, wherein the first signal on each of the plurality of downlink beams corresponds to specific time-frequency resources, and the interference measurement results, measured when the at least one weak beam is used, are transmitted along with an indication of time-frequency resources for the first signal on the at least one weak beam or with a beam ID of the at least one weak beam.

4. The electronic device of claim 1, wherein determining the one or more weak beams for the terminal comprises:
determining, a downlink beam with received signal to interference and noise ratio (SINR) or a received power lower than a threshold for the terminal, as a weak beam for the terminal; and/or
wherein the one or more weak beams for the terminal are determined based on a single measurement result of each of the plurality of downlink beams, or based on statistics for multiple measurement results of each of the plurality of downlink beams.

5. (canceled)

6. The electronic device of claim 3, wherein the interference measurement results are based on a single interference measurement result or statistics for multiple interference measurement results; and/or
wherein the interference measurement results, measured when the at least one weak beam is used, are transmitted in a channel state information (CSI) report.

7. (canceled)

8. The electronic device of claim 1, wherein the processing circuit is further configured to:
transmit, to the base station, information on the one or more weak beams for the terminal;
receive, from the base station, information on a subset of the one or more weak beams; and
measure interferences from one or more neighboring cells when a weak beam of the subset is used to transmit the first signal.

9. The electronic device of claim 8, wherein the information on the subset is received by downlink control information, and the information on the subset is received by at least one of the following:
a bitmap with a plurality of bits corresponding to the plurality of downlink beams, and each bit indicating whether a corresponding downlink beam belongs to the subset; or
pre-configured information corresponding to a particular subset of weak beams.

10. The electronic device of claim 1, wherein the processing circuit is further configured to:
measure, by the first signal, the plurality of downlink beams of the serving cell, to determine one or more strong beams from the plurality of downlink beams for the terminal; and
perform beam management by using the one or more strong beams.

11. An electronic device for a base station side in a wireless communication system, comprising a processing circuit configured to:
transmit a first signal by a plurality of downlink beams of a serving cell; and
receive interference measurement results, measured when at least one weak beam is used, from a terminal, wherein, the interference measurement results are obtained by the terminal by measuring interferences from one or more neighboring cells when one or more weak beams for the terminal are used to transmit the first signal.

12. The electronic device of claim 11, wherein the first signal is non-zero power and the first signal comprises at least one of a downlink reference signal or a synchronization signal block (SSB).

13. The electronic device of claim 12, wherein the first signal on each of the plurality of downlink beams of the serving cell corresponds to specific time-frequency resources, and the interference measurement results, measured when the at least one weak beam is used, are transmitted along with an indication of time-frequency resources for the first signal on the at least one weak beam or with a beam ID of the at least one weak beam.

14. The electronic device of claim 11, wherein the one or more weak beams for the terminal comprise a downlink beam with received signal to interference and noise ratio (SINR) or a received power lower than a threshold for the terminal; and/or
wherein receiving the interference measurement results, measured when at least one weak beam is used, from the terminal comprises:
receiving the interference measurement results, measured when the at least one weak beam is used, in a channel state information (CSI) report.

15. (canceled)

16. The electronic device of claim 11, wherein the processing circuit is further configured to:
receive, from the terminal, information on one or more weak beams for the terminal;
transmit, to the terminal, information on a subset of the one or more weak beams, for the terminal to measure interferences from one or more neighboring cells when a weak beam of the subset is used to transmit the first signal.

17. The electronic device of claim 16, wherein the information on the subset is transmitted by downlink control information, and the information on the subset is transmitted by at least one of the following:
a bitmap with a plurality of bits corresponding to the plurality of downlink beams, and each bit indicating whether a corresponding downlink beam belongs to the subset; or
pre-configured information corresponding to a particular subset of weak beams.

18. The electronic device of claim 11, wherein the processing circuit is further configured to communicate with the one or more neighboring cells to determine one or more downlink beams of the one or more neighboring cells that interfere with the terminal.

19. The electronic device of claim 18, wherein communicating with the one or more neighboring cells comprises:
determining time information corresponding to the interference in the interference measurement results;
transmitting, to the one or more neighboring cells, the time information; and
receiving, from the one or more neighboring cells, interference beam information including one or more downlink beams of the one or more neighboring cells corresponding to the time information; and/or
wherein the time information is characterized as a slot index and a symbol index; and/or
wherein the processing circuit is further configured to:
determine one or more downlink beams of the one or more neighboring cells with interferences based on the interference beam information in a certain period of time.

20. (canceled)

21. (canceled)

22. The electronic device of claim 11, wherein the processing circuit is further configured to:
receive, from the one or more neighboring cells, time information corresponding to the neighbor cell interferences measured by each neighboring cell; and
transmit, to the one or more neighboring cells, interference beam information including one or more downlink beams of the serving cell corresponding to the time information.

23. A wireless communication method for a terminal side, comprising:
measuring a plurality of downlink beams of a serving cell, to determine one or more weak beams from the plurality of downlink beams for the terminal;
measuring interferences from one or more neighboring cells when the one or more weak beams are used to transmit a first signal; and
transmitting interference measurement results, measured when at least one weak beam is used, to a base station of the serving cell.

24. A wireless communication method for a base station side, comprising:
transmitting a first signal by a plurality of downlink beams of a serving cell; and
receiving interference measurement results, measured when at least one weak beam is used, from a terminal, where the interference measurement results are obtained by the terminal by measuring interferences from one or more neighboring cells when one or more weak beams for the terminal are used to transmit the first signal.

25. A non-transitory computer-readable storage medium storing one or more instructions that, when executed by one or more processors of an electronic device, cause the electronic device to perform the method of claim 23.

26. (canceled)

27. A non-transitory computer-readable storage medium storing one or more instructions that, when executed by one or more processors of an electronic device, cause the electronic device to perform the method of claim 24.
